(19) United States
(12) Patent Application Publication
(10) Pub. No.: US 2026/0204007 A1
(43) Pub. Date: Jul. 16, 2026

(54) DATA PROCESSING

(71) Applicant: TENCENT TECHNOLOGY (SHENZHEN) COMPANY LIMITED, Shenzhen (CN)

(72) Inventors: Yijie SHI, Shenzhen (CN); Chen QIAO, Shenzhen (CN); Xueqiang WANG, Shenzhen (CN)

(73) Assignee: TENCENT TECHNOLOGY (SHENZHEN) COMPANY LIMITED, Shenzhen (CN)

(21) Appl. No.: 19/196,680

(22) Filed: May 1, 2025

Related U.S. Application Data
(63) Continuation of application No. PCT/CN2024/075504, filed on Feb. 2, 2024.

(30) Foreign Application Priority Data
Mar. 29, 2023 (CN) 202310321006.8

(51) Int. Cl. G06T 15/50; G06T 15/04; G06T 15/08

(52) U.S. Cl. CPC G06T 15/506; G06T 15/04; G06T 15/08

(57) ABSTRACT

A first rendering rule and a second rendering rule are acquired. The first rendering rule is configured for virtual scene rendering with more medium effects than the second rendering rule, and the second rendering rule is configured for rendering with a medium scattering effect. A sample volume texture of a sample map is acquired, the sample volume texture is generated by the first rendering rule. Based on the sample volume texture, one or more first rendering values of the sample map and reference depth data of the sample map in the sample environment configuration are determined. One or more second rendering values of the sample map in the sample environment configuration are determined based on the reference depth data and the second rendering rule with an initial rendering parameter for a training. The training is performed to obtain a service rendering parameter associated with the sample environment configuration.

### RELATED APPLICATIONS

The present application is a continuation of International Application No. PCT/CN2024/075504, filed on Feb. 2, 2024, which claims priority to Chinese Patent Application No. 202310321006.8, filed on Mar. 29, 2023. The entire disclosures of the prior applications are hereby incorporated by reference.

### FIELD OF THE TECHNOLOGY

This application relates to the technical field of computers, including data processing.

### BACKGROUND OF THE DISCLOSURE

In the related art, when a scattering real-time rendering system simulates atmospheric scattering, the following two phenomena are mainly included: a sky effect and an aerial perspective effect. The sky effect refers to the fact that the sky appears blue during the daytime and red at the horizon in the evening. It is usually realized with the help of a sky sphere. The aerial perspective effect refers to a fog effect (also referred to as atmospheric fog) caused by atmospheric scattering phenomena on a distant object.

For the phenomenon of the aerial perspective effect, in a scattering simulation method in the related art, a rendering rule (for example, a Hoffman02 algorithm) obtained based on a simplification of a physical formula may be adopted to simulate the phenomenon. However, since the rendering rule simplifies a physical algorithm, there is a problem of difficult parameter adjustment. Therefore, to achieve a target effect, in most cases, a rendering parameter in the rendering rule needs to be continuously manually attempted, and fine adjustment is performed on the rendering parameter. This is very time-consuming and difficult for art creation. That is, the scattering simulation method in the related art needs to spend lots of manpower costs and time costs. Consequently, taking both the rendering efficiency and the rendering effect into consideration is difficult.

### SUMMARY

Embodiments of this disclosure provide a data processing method and apparatus, a computer device, a computer-readable storage medium, and a computer program product, which may improve a rendering effect of scatter simulation under the condition of ensuring the rendering efficiency.

Some aspects of the present disclosure provide a method of data processing (e.g., for parameter training). For example, a first rendering rule and a second rendering rule are acquired. The first rendering rule is configured for virtual scene rendering with more medium effects than the second rendering rule, and the second rendering rule is configured for rendering with a medium scattering effect. A sample volume texture of a sample map in a sample environment configuration is acquired, the sample volume texture is generated by the first rendering rule. Based on the sample volume texture, one or more first rendering values of the sample map and reference depth data of the sample map in the sample environment configuration are determined. One or more second rendering values of the sample map in the sample environment configuration are determined based on the reference depth data and the second rendering rule with an initial rendering parameter for training. The training is performed based on the one or more second rendering values and the one or more first rendering values to obtain a service rendering parameter associated with the sample environment configuration.

Some aspects of the disclosure provide a method of data processing (e.g., for rendering). In some examples, a service environment configuration for a first map is acquired when a scattering simulation rendering is to be performed on the first map according to a second rendering rule, the second rendering rule has one or more parameters trained based on a first rendering rule with more medium effects than the second rendering rule. When the service environment configuration corresponds to a sample environment configuration that has being trained, a service rendering parameter associated with the sample environment configuration is acquired. The service rendering parameter is obtained by a training with an initial rendering parameter in the second rendering rule based on one or more first rendering values of a sample map in the sample environment configuration. The one or more first rendering values of the sample map are determined based on a sample volume texture of the sample map. The sample volume texture of the sample map is generated by the first rendering rule. A medium scattering effect of the first map is rendered based on the service rendering parameter and the second rendering rule to obtain a second map.

Some aspects of the disclosure provide a data processing apparatus including processing circuitry. The processing circuitry is configured to acquire a first rendering rule and a second rendering rule, the first rendering rule is configured for virtual scene rendering with more medium effects than the second rendering rule, and the second rendering rule is configured for rendering with a medium scattering effect. The processing circuitry is also configured to acquire a sample volume texture of a sample map in a sample environment configuration, the sample volume texture is generated by the first rendering rule. Also, the processing circuitry is configured to determine, based on the sample volume texture, one or more first rendering values of the sample map and reference depth data of the sample map in the sample environment configuration, determine one or more second rendering values of the sample map in the sample environment configuration based on the reference depth data and the second rendering rule with an initial rendering parameter for a training, and perform the training based on the one or more second rendering values and the one or more first rendering values to obtain a service rendering parameter associated with the sample environment configuration.

The embodiments of this disclosure provide a data processing method, including the following operations: acquiring a rendering rule, the rendering rule including a first rendering rule and a second rendering rule; the first rendering rule being configured for rendering a virtual scene containing a medium; and the second rendering rule being configured for rendering a medium scattering effect; acquiring a sample volume texture of a sample map generated by the first rendering rule; determining, based on the sample volume texture, an actual rendering value of the sample map in a sample environment configuration and reference depth data of the sample map; determining a predicted rendering value of the sample map in the sample environment configuration based on an initial rendering parameter in the second rendering rule and the reference depth data; and training the initial rendering parameter based on the predicted rendering value and the actual rendering value to obtain a service rendering parameter matching the sample environment configuration, the service rendering parameter being configured for rendering a medium scattering effect of a first map; and a service environment configuration of the first map being the sample environment configuration.

The embodiments of this disclosure provide a data processing method, including the following operations: acquiring a service environment configuration for a first map when performing scattering simulation rendering on the first map; acquiring, if the service environment configuration is a sample environment configuration, a service rendering parameter matching the sample environment configuration, the service rendering parameter being obtained after training an initial rendering parameter in a second rendering rule based on a predicted rendering value and an actual rendering value of a sample map in the sample environment configuration; the actual rendering value of the sample map being determined based on a sample volume texture of the sample map; the sample volume texture of the sample map being generated by a first rendering rule; the first rendering rule being configured for rendering a virtual scene containing a medium; and the second rendering rule being configured for rendering a medium scattering effect; and rendering a medium scattering effect of the first map based on the service rendering parameter and the second rendering rule to obtain a second map.

The embodiments of this disclosure provide a data processing apparatus, including: a rule acquisition module configured to acquire a rendering rule, the rendering rule including a first rendering rule and a second rendering rule; the first rendering rule being configured for rendering a virtual scene containing a medium; and the second rendering rule being configured for rendering a medium scattering effect; a sample reference module configured to acquire a sample volume texture of a sample map generated by the first rendering rule and determine, based on the sample volume texture, an actual rendering value of the sample map in a sample environment configuration and reference depth data of the sample map; a sample prediction module configured to determine a predicted rendering value of the sample map in the sample environment configuration based on an initial rendering parameter in the second rendering rule and the reference depth data; and a training module configured to train the initial rendering parameter based on the predicted rendering value and the actual rendering value to obtain a service rendering parameter matching the sample environment configuration, the service rendering parameter being configured for rendering a medium scattering effect of a first map; and a service environment configuration of the first map being the sample environment configuration.

The embodiments of this disclosure provide a data processing apparatus, including: a configuration acquisition module configured to acquire a service environment configuration for a first map when performing scattering simulation rendering on the first map; a service parameter acquisition module configured to acquire, if the service environment configuration is a sample environment configuration, a service rendering parameter matching the sample environment configuration, the service rendering parameter being obtained after training an initial rendering parameter in a second rendering rule based on a predicted rendering value and an actual rendering value of a sample map in the sample environment configuration; the actual rendering value of the sample map being determined based on a sample volume texture of the sample map; the sample volume texture of the sample map being generated by a first rendering rule; the first rendering rule being configured for rendering a virtual scene containing a medium; and the second rendering rule being configured for rendering a medium scattering effect; and a rendering module configured to render a medium scattering effect of the first map based on the service rendering parameter and the second rendering rule to obtain a second map.

This disclosure provides a processor (an example of processing circuitry), a memory, and a network interface, the processor being connected to the memory and the network interface, the network interface being configured to provide a data communication function, the memory being configured to store a computer program, and the processor being configured to invoke the computer program to cause the computer device to perform the data processing method provided by the embodiments of this disclosure.

The embodiments of this disclosure provide a computer-readable storage medium (e.g., non-transitory computer-readable storable medium), having a computer program stored therein, the computer program being adapted to be loaded and executed by a processor, to cause a computer device having the processor to perform the data processing method provided by the embodiments of this disclosure.

The embodiments of this disclosure provide a computer program product, including a computer program, the computer program being stored in a computer-readable storage medium; a processor of a computer device reading the computer program from the computer-readable storage medium, and the processor executing the computer program to cause the computer device to perform the data processing method provided in the embodiments of this disclosure.

In the embodiments of this disclosure, a computer device having a rendering function acquires the rendering rule when performing simulation rendering on the medium scattering effect. The rendering rule herein may include the first rendering rule configured for rendering the virtual scene containing a medium and the second rendering rule configured for rendering the medium scattering effect. When acquiring the sample map, the computer device does not need to consume a large amount of time to manually adjust the initial rendering parameter in the second rendering rule, but may directly acquire the volume texture (i.e., the sample volume texture) of the sample map through the first rendering rule, and may further rapidly determine the actual rendering value of the sample map in the sample environment configuration and the reference depth data of the sample map based on the sample volume texture.

In addition, the computer device may determine the predicted rendering value of the sample map in the sample environment configuration through the initial rendering parameter (i.e., the rendering parameter before training) in the second rendering rule and the reference depth data. Then, the computer device may train the initial rendering parameter based on the predicted rendering value and the actual rendering value to obtain the service rendering parameter matching the sample environment configuration. The service rendering parameter herein is a training-completed rendering parameter. The service rendering parameter may be configured for rendering the medium scattering effect of the first map, and the service environment configuration of the first map is the sample environment configuration. It can be seen that in the embodiments of this disclosure, the initial rendering parameter in the second rendering rule does not need to be manually adjusted, but the hard-to-adjust rendering parameter in the second rendering rule may be directly deduced by acquiring intermediate data, i.e., the sample volume texture, of the physical algorithm of the first rendering rule. This means that in the embodiments of this disclosure, when the medium scattering effect is rendered, the second rendering rule is not directly used, but the service rendering parameter is trained by combining the first rendering rule and the second rendering rule so that the service rendering parameter may be obtained more quickly and accurately. In this way, when the medium scattering effect of the first map is rendered subsequently, not only the rendering effect may be ensured, but also the rendering efficiency may be improved. That is, the scattering simulation method used in the embodiments of this disclosure may take both the rendering effect and the rendering efficiency into consideration.

### BRIEF DESCRIPTION OF THE DRAWINGS

FIG. 1 is a schematic structural diagram of a network architecture according to an embodiment of this disclosure.

FIG. 2 is a schematic diagram of a framework for training rendering parameters according to an embodiment of this disclosure.

FIG. 3 is a schematic flowchart of a data processing method according to an embodiment of this disclosure.

FIG. 4 is a schematic flowchart of a training parameter according to an embodiment of this disclosure.

FIG. 5 is a schematic flowchart of another data processing method according to an embodiment of this disclosure.

FIG. 6 is a schematic diagram of a scene for rendering a medium scattering effect according to an embodiment of this disclosure.

FIG. 7 is a schematic structural diagram of a data processing apparatus according to an embodiment of this disclosure.

FIG. 8 is a schematic structural diagram of another data processing apparatus according to an embodiment of this disclosure.

FIG. 9 is a schematic diagram of a computer device according to an embodiment of this disclosure.

FIG. 10 is a schematic structural diagram of a data processing system according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

Light scattering refers to a phenomenon that when a light beam passes through an uneven medium, a part of the light beam deviates from an original direction and dispersedly spreads, and light may also be seen from a side direction. When light passes through a medium such as air with dirt or a colloidal solution, and when solar radiation encounters air molecules, dust particles, cloud droplets, and other particles in the atmosphere, scattering may occur. For example, a beam of light is white after passing through the diluted milk, but is light blue when viewed from the side and above. The medium herein may include a gas medium (for example, air), a liquid medium (for example, water, milk, and oil), and a solid medium (for example, glass). This is not limited herein. If the medium is air, a virtual scene containing the medium and rendered by the first rendering rule may be a sky effect, and a medium scattering effect rendered by the second rendering rule may be an aerial perspective effect. The sky effect may be an effect that the sky appears blue during the daytime and red at the horizon in the evening. The aerial perspective effect may be a fog effect caused by atmospheric scattering phenomena on a distant object.

Atmospheric scattering refers to a scattering phenomenon that occurs when light passes through substances such as gas modules and aerosol particles in the atmosphere, and is also a main reason why the sky appears blue during the daytime and red at the horizon in the evening on the Earth. In graphics, an atmospheric scattering system generally includes simulations of three physical phenomena: Rayleigh scattering, Mie scattering, and light energy absorption (for example, ozone absorption) by air.

In this embodiment of this disclosure, a scattering proportion of intensities of light of different colors (i.e., different wave lengths) may be represented through scattering coefficients. Since scattering occurs in all directions, a phase function may be adopted to represent a proportion of light scattered at different angles. Simulations of several common physical phenomena in the atmospheric scattering system are described below.

Physical phenomenon 1: Rayleigh scattering. The scattering is caused by air molecules, and intensities of the scattered light in various directions are different. The intensities are inversely proportional to the fourth power of a wave length of incident light. Therefore, the Rayleigh scattering is the fundamental reason why the atmosphere appears blue during the daytime and orange-red at the horizon in the evening. Formulas associated with the Rayleigh scattering may refer to the following formula (1) and formula (2):

$${β}_{R}^{S} ( h , λ ) = \frac{8 {{π}^{3} ( {n}^{2} - 1 )}^{2}}{3 N {λ}^{4}} {e}^{- \frac{h}{{H}_{R}}}$$

$$where {β}_{R}^{S} ( h , λ ) ,$$

represents a scattering coefficient of the Rayleigh scattering, and the scattering coefficient represents a proportion of loss to scattering of light after a collision; h represents a height of a pixel point; λ represents the wave length of the incident light; n represents a refractive index of air; N represents the molecular number density of the standard atmosphere, i.e., the number of molecules per cubic meter; and H_{R} represents a parameter related to an altitude.

When the Rayleigh scattering is simulated, the scattering coefficient in this embodiment of this disclosure may indicate a calculation result of

$$\frac{8 {{π}^{3} ( {n}^{2} - 1 )}^{2}}{3 N {λ}^{4}}$$

in formula (1), often expressed in terms of β_{R} (i.e., a first scattering parameter). The parameter is usually calculated through the foregoing formula according to a red-green-blue (RGB) value corresponding to a wave length and reference data obtained through atmospheric measurement. Sometimes, the parameter is also exposed to a service object (for example, a user) so that the service object manually adjusts a final result to simulate atmospheric effects of various environment configurations (for example, planets such as the Mars or the Earth).

$${P}_{R} ( μ ) = \frac{3}{16 π} ( 1 + {μ}^{2} ) , \qquad ( 2 )$$

where P_{R}(μ) represents a phase function of the Rayleigh scattering and is configured for controlling a scattering geometry, and P_{R}(μ) represents a relative ratio of light lost in a particular direction.

$$\frac{3}{16 π}$$

is used as a normalization factor. Therefore, an integral on a unit sphere is 1; μ=cos θ, representing a cosine value of θ; and θ may be configured for representing an included angle between directional light and a current line of sight.

Physical phenomenon 2: Mie scattering. The Mie scattering is caused by ellipsoidal particles, such as aerosol particles and water-drop particles, in the air. The Mie scattering shows relatively strong anisotropy. That is, a relatively large part of light passing through the particles is scattered towards a direction that forms an obtuse angle with an original light propagation direction, or even an opposite direction of the light propagation direction. Therefore, the Mie scattering is a main cause of a circle of whitish halos around the sun during the daytime. Formulas associated with the Mie scattering may refer to the following formula (3) and formula (4):

$${β}_{M}^{S} ( h , λ ) = {β}_{M}^{S} ( 0 , λ ) {e}^{- \frac{h}{{H}_{M}}} \qquad ( 3 )$$

$$where {β}_{M}^{s} ( h , C ) ,$$

represents a scattering coefficient of the Mie scattering and may be expressed in terms of β_{M} (i.e., a second scattering parameter); h and H_{M} are configured for representing parameters related to an altitude; λ is configured for representing the wave length of the incident light.

$${P}_{M} ( μ ) = \frac{3}{8 π} \frac{( 1 - {g}^{2} ) ( 1 + {μ}^{2} )}{( 2 + {g}^{2} ) {( 1 + {g}^{2} - 2 g μ )}^{\frac{3}{2}}} , \qquad ( 4 )$$

where P_{M}(μ) represents a common phase function (CornetteShanks phase function) of the Mie scattering; g is a parameter configured for controlling anisotropy of the Mie scattering. Certainly, in this embodiment of this disclosure, other phase functions (for example, Heyney Greenstein Phase function) may alternatively be adopted to simulate the Mie scattering phenomenon.

Physical phenomenon 3: light energy absorption by air. The absorption mainly exists in the ozone phenomenon. However, since the impact is small, the simulation effect of this physical phenomenon is temporarily ignored in this embodiment of this disclosure.

A data processing method provided by this embodiment of this disclosure is described below with reference to the simulation of the foregoing several physical phenomena. A network architecture in an embodiment of this disclosure is first described herein.

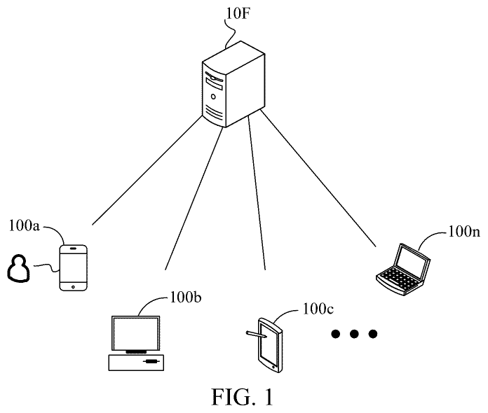

Referring to FIG. 1, FIG. 1 is a schematic structural diagram of a network architecture according to an embodiment of this disclosure. As shown in FIG. 1, the network architecture may include a server 10F and a terminal device cluster. The terminal device cluster may include one or more terminal devices. As shown in FIG. 1, the terminal device cluster may include a terminal device 100a, a terminal device 100b, a terminal device 100c, . . . , and a terminal device 100n. As shown in FIG. 1, the terminal device 100a, the terminal device 100b, the terminal device 100c, . . . , and the terminal device 100n may establish a network connection with the foregoing server 10F so that each terminal device may perform data interaction with the server 10F through the network connection. The network connection herein does not limit a connection manner, and may be a direct or indirect connection in a wired communication manner, may be a direct or indirect connection in a wireless communication manner, or may be a connection in other manners. This is not limited in the embodiments of this disclosure herein.

Each terminal device in the terminal device cluster may include smart terminals with a data processing function such as a smartphone, a tablet computer, a notebook computer, a desktop computer, a smart speaker, a smart watch, an in-vehicle terminal, and a smart television. Each terminal device in the terminal device cluster shown in FIG. 1 may be installed with an application client. When the application client runs in each terminal device, the application client may perform data interaction with the server 10F shown in FIG. 1. The application client may include application clients such as a social client, a multimedia client (e.g., a video client), an entertainment client (e.g., a game client), an information flow client, an educational client, and a livestreaming client. The application client may be an independent client, or may be an embedded sub-client integrated in a client (such as the social client, the educational client, or the multimedia client). This is not limited herein.

As shown in FIG. 1, the server 10F in this embodiment of this disclosure may be a server corresponding to the application client. The server 10F may be an independent physical server, may be a server cluster or a distributed system including a plurality of physical servers, or may be a cloud server providing a cloud computing service. The numbers of terminal devices and servers are not limited in this embodiment of this disclosure.

For ease of understanding, in this embodiment of this disclosure, one terminal device may be selected from a plurality of terminal devices shown in FIG. 1 as a target terminal device. For example, in this embodiment of this disclosure, the terminal device 100a shown in FIG. 1 may be used as the target terminal device, and the target terminal device may be integrated with an application client. In this case, the target terminal device may implement data interaction with the server 10F through a service data platform corresponding to the application client. A component (i.e., an atmospheric rendering component) configured to perform scattering simulation rendering may be deployed in a service engine (for example, a game engine and a physical simulation engine) in the application client herein. For example, the atmospheric rendering component deployed by the game engine (for example, a UE4 engine) may be a Sky Atmosphere component (also referred to as a SkyAtmosphere module). The atmospheric rendering component may be configured to train a rendering parameter matching a sample environment configuration.

The sample environment configuration herein may be configured by a service object (for example, a user) according to an actual simulation environment. The configuration herein may include a first configuration associated with a planet, may include a second configuration associated with position information of a planet, and may further include other types of configurations. This is not limited herein. For example, the service object may select a planet (for example, the Mars) from configuration options (for example, the Earth, the Mars, the moon, and a customized planet) corresponding to the first configuration as the first configuration so that the computer device subsequently simulates a rendering effect of a map on the Mars. In some embodiments, after making a selection for the first configuration, the service object may further make a selection for the second configuration based on the first configuration. For example, after the first configuration is selected as the Earth, the service object may further select, based on the first configuration, a piece of position information (for example, the equator) from configuration options (for example, the equator, the arctic, and customized longitude and latitude coordinates) corresponding to the second configuration as the second configuration so that the computer device subsequently simulates a rendering effect of a map on the equator of the Earth. In other words, in this embodiment of this disclosure, various scattering systems may be adjusted to simulate rendering effects of various planets, or various rendering effects may be customized. Examples are not provided herein again.

A scattering simulation method according to this embodiment of this disclosure may be performed by a computer device having a rendering function. The computer device may be the server 10F shown in FIG. 1, or may be any terminal device in the terminal device cluster shown in FIG. 1, for example, the terminal device 100a. This is not limited herein.

In a parameter training process, the computer device may acquire a rendering rule. The rendering rule herein may include not only a first rendering rule configured for rendering a virtual scene containing a medium, for example, a Hillaire20 algorithm, but also a second rendering rule configured for rendering a medium scattering effect, for example, a Hoffman02 algorithm. To reduce manpower costs and time costs, the computer device may acquire intermediate data (i.e., a sample volume texture of a sample map, for example, a 3D Volume texture) obtained through the first rendering rule, and may further determine, based on the sample volume texture, an actual rendering value of the sample map in a sample environment configuration and reference depth data of the sample map. The actual rendering value and the reference depth data of the sample map herein are both determined according to a reference image of the sample map in the sample environment configuration, and the actual rendering value refers to a rendering value of the reference image. The reference depth data is initial depth data of the reference image, i.e., being configured for representing a distance between a current observation point (for example, a position of a virtual character in a game scene) and a target point (for example, a coordinate position corresponding to a to-be-rendered pixel point) of the reference image. Then, the computer device may determine a predicted rendering value of the sample map in the sample environment configuration through an initial rendering parameter in the second rendering rule and the reference depth data, and may further train the initial rendering parameter based on the predicted rendering value and the actual rendering value to obtain a service rendering parameter matching the sample environment configuration. The service rendering parameter herein is configured for rendering a medium scattering effect of a first map, and an environment configuration (i.e., a service environment configuration) of the first map is the sample environment configuration.

The scattering simulation method according to this embodiment of this disclosure may be applied to a plurality of scenes. For example, in a game scene, a sample map obtained by the computer device may be a game map (for example, a map corresponding to a wild shooting scene in a competitive game). In this case, the computer device may train the initial rendering parameter in the second rendering rule by combining the first rendering rule and the second rendering rule to quickly and accurately obtain the service rendering parameter so that a game rendering effect can be more accurately presented when the service rendering parameter is subsequently applied, thereby improving game experience of a user. For another example, in a virtual reality scene (i.e., a VR scene), the sample map obtained by the computer device may be a virtual map (for example, a map corresponding to a forest scene in a virtual world). In this case, the computer device may train the initial rendering parameter in the second rendering rule by combining the first rendering rule and the second rendering rule to quickly and accurately obtain the service rendering parameter so that an aerial perspective effect may be simulated more accurately and in real time when the service rendering parameter is subsequently applied. Thus, a user in the virtual world has an immersive feeling, thereby improving the interest.

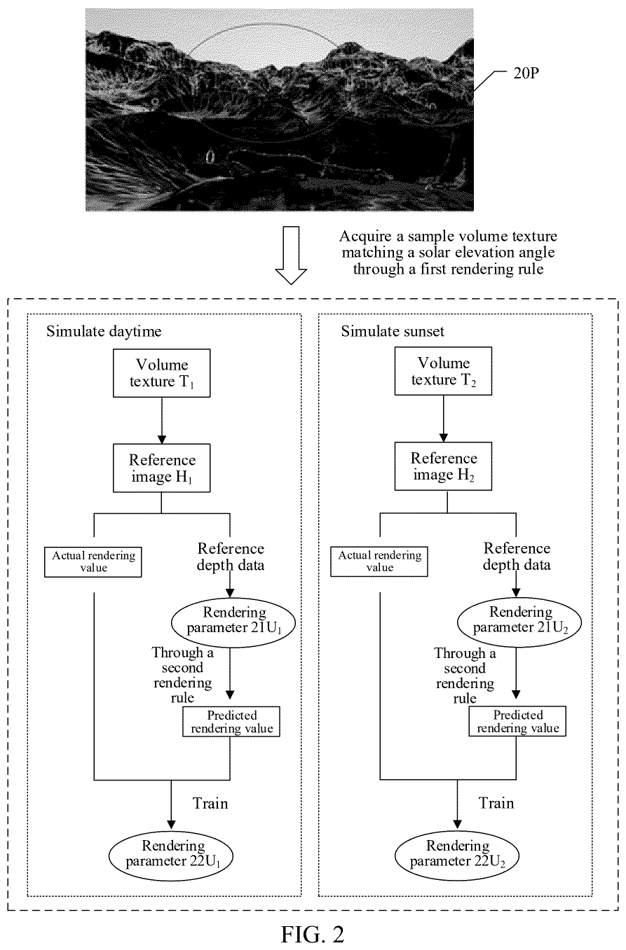

For ease of understanding, in some embodiments, referring to FIG. 2, FIG. 2 is a schematic diagram of a framework for training rendering parameters according to an embodiment of this disclosure. As shown in FIG. 2, the computer device in this embodiment of this disclosure may be a computer device having a rendering function. The computer device may be any terminal device in the terminal device cluster shown in FIG. 1, for example, the terminal device 100a. The computer device may further be the server 10F shown in FIG. 1. The computer device is not limited herein. The medium in this embodiment of this disclosure may be air as an example, which means that a virtual scene including the medium may have a sky effect, and a medium scattering effect may be an aerial perspective effect.

Since a rendering rule (i.e., the second rendering rule) configured for rendering the aerial perspective effect has a problem of difficult parameter adjustment, in a parameter training process, the computer device needs to acquire a map (i.e., a sample map), for example, a map 20P shown in FIG. 2, configured for training an initial rendering parameter of the second rendering rule. The map 20P may be an original map on which scattering simulation rendering is not performed, or may be a map obtained after simulation rendering is performed on a sky effect of the original map. This is not limited herein.

The rendering rule in this embodiment of this disclosure may include not only a first rendering rule (i.e., a new physical algorithm) configured for rendering the sky effect, but also the second rendering rule (i.e., an old simplification algorithm) configured for rendering the aerial perspective effect. That is, in this embodiment of this disclosure, the aerial perspective effect can be quickly and accurately rendered in real time by combining the old simplification algorithm and the new physical algorithm.

The computer device may acquire a plurality of sample volume textures of the map 20P in the sample environment configuration (for example, the earth) through the first rendering rule. One sample volume texture may be a volume texture that is acquired by the computer device for the map 20P and matches a virtual light source elevation angle (i.e., an elevation angle Φ corresponding to light emitted by a virtual light source). An angle interval of the virtual light source elevation angle may include a first angle threshold and a second angle threshold. Both the first angle threshold and the second angle threshold may be dynamically adjusted according to an actual requirement. This is not limited herein. The virtual light source may be a light source capable of emitting light, for example, a light source such as a flashlight and the sun.

When the virtual light source is the sun, the virtual light source elevation angle herein may be a solar elevation angle, i.e., an included angle between a solar ray and the horizontal line. For example, the first angle threshold may be −10 degrees, and the second angle threshold may be 90 degrees. In this embodiment of this disclosure, if the solar elevation angle is a negative number, a sample volume texture matching the solar elevation angle is a volume texture configured for simulating that the sun sinks below the horizontal line. If the solar elevation angle is 0 degree, the sample volume texture matching the solar elevation angle is a volume texture configured for simulating sunset. If the solar elevation angle is a positive number, the sample volume texture matching the solar elevation angle is a volume texture configured for simulating daytime. If the solar elevation angle is 90 degrees, the sample volume texture matching the solar elevation angle is a volume texture configured for simulating noon.

For ease of description, in this embodiment of this disclosure, there may be two sample volume textures, including a volume texture T₁ configured for simulating daytime and a volume texture T₂ configured for simulating sunset. A virtual light source elevation angle (for example, an elevation angle Φ₁) corresponding to the volume texture T₁ may be 10 degrees, and a virtual light source elevation angle (for example, an elevation angle Φ₂) corresponding to the volume texture T₂ may be 0 degree.

For the volume texture T₁, the computer device may determine a reference image, i.e., a reference image H₁ shown in FIG. 2, of the map 20P at the elevation angle Φ₁ corresponding to the volume texture T₁, and then determine, based on the reference image H₁, an actual rendering value of the map 20P at the elevation angle Φ₁ in the sample environment configuration and reference depth data. The reference depth data herein is configured for representing a distance between a current observation point (for example, a position of a virtual character in a game scene) and a target point (for example, a coordinate position corresponding to a to-be-rendered pixel point) of the reference image H₁. Then, the computer device may acquire an initial rendering parameter of the second rendering rule, for example, a rendering parameter 21U₁ matching the elevation angle Φ₁, and then determine a predicted rendering value of the map 20P at the elevation angle Φ₁ in the sample environment configuration through the second rendering rule, the rendering parameter 21U₁ and the reference depth data corresponding to the reference image H₁. In this case, the computer device may train the rendering parameter 21U₁ based on the predicted rendering value and the actual rendering value of the map 20P at the elevation angle Φ₁ to obtain a service rendering parameter, for example, a rendering parameter 22U₁, matching the elevation angle Φ₁ in the sample environment configuration. Similarly, for the volume texture T₂, the computer device may determine a reference image, i.e., a reference image H₂ shown in FIG. 2, of the map 20P at the elevation angle Φ₂ corresponding to the volume texture T₂, and then determine, based on the reference image H₂, an actual rendering value of the map 20P at the elevation angle Φ₂ in the sample environment configuration and reference depth data. The reference depth data herein is configured for representing a distance between a current observation point (for example, a position of a virtual character in a game scene) and a target point (for example, a coordinate position corresponding to a to-be-rendered pixel point) of the reference image H₂. Then, the computer device may acquire an initial rendering parameter of the second rendering rule, for example, a rendering parameter 21U₂ matching the elevation angle Φ₂, and then determine a predicted rendering value of the map 20P at the elevation angle Φ₂ in the sample environment configuration through the second rendering rule, the rendering parameter 21U₂ and the reference depth data corresponding to the reference image H₂. In this case, the computer device may train the rendering parameter 21U₂ based on the predicted rendering value and the actual rendering value of the map 20P at the elevation angle Φ₂ to obtain a service rendering parameter, for example, a rendering parameter 22U₂, matching the elevation angle Φ₂ in the sample environment configuration.

The rest may be deduced by analogy. The computer device may further refer to a parameter training method of the rendering parameter 22U₁ and a rendering parameter 22U₂ to obtain service rendering parameters matching others solar elevation angles in the sample environment configuration, and then service rendering parameters at the solar elevation angles may be determined as a service rendering parameter set matching the sample environment configuration. Each service rendering parameter in the service rendering parameter set may be configured for rendering an air projection effect of a map (i.e., a first map) of which a service environment configuration is the sample environment configuration.

It can be seen that since the scattering simulation (i.e., the atmospheric scattering simulation) method provided in this embodiment of this disclosure does not need manual participation, the service rendering parameters of different solar elevation angles in the sample environment configuration are obtained by combining the first rendering rule and the second rendering rule so that when the aerial perspective effect of the first map is subsequently rendered in real time based on the service rendering parameters, labor costs and time costs can be greatly reduced. Thus, the rendering efficiency can be further improved while ensuring the rendering effect. That is, the atmospheric scattering simulation method can take both the rendering effect and the rendering efficiency into consideration.

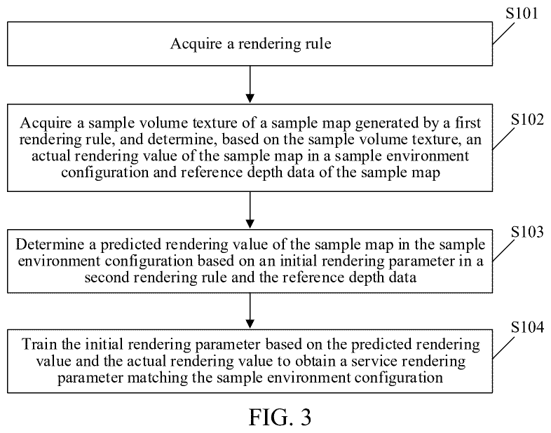

In this embodiment of this disclosure, when rendering a medium scattering effect of a map, the computer device having the rendering function may train the initial rendering parameter in the second rendering rule by combining the first rendering rule and the second rendering rule to quickly and accurately obtain the service rendering parameter matching the sample environment configuration. An implementation of the parameter training may refer to the embodiments corresponding to FIG. 3 to FIG. 6.

In some embodiments, referring to FIG. 3, FIG. 3 is a schematic flowchart of a data processing method according to an embodiment of this disclosure. As shown in FIG. 3, the method may be performed by a computer device having a rendering function. The computer device may be a terminal device, for example, any terminal device in the terminal device cluster shown in FIG. 1, such as the terminal device 100a having a parameter training function. The computer device may further be a server, for example, the server 10F shown in FIG. 1. This is not limited herein. For ease of understanding, this embodiment of this disclosure is described using an example in which the method is performed by a server having a rendering function. The method may include at least the following operation S101 to operation S104.

Operation S101: acquire a rendering rule.

The rendering rule herein may be a rule configured for performing scattering simulation rendering and may include a first rendering rule and a second rendering rule. The first rendering rule may be configured for rendering a virtual scene (for example, a sky effect) containing a medium. For example, the first rendering rule may be a Hillaire20 algorithm. The second rendering rule may be configured for rendering a medium scattering effect (for example, an aerial perspective effect). For example, the second rendering rule may be a Hoffman02 algorithm.

In this embodiment of this disclosure, the first rendering rule is a new physical algorithm compared with a rendering rule in the related art, and the second rendering rule may be an old simplification algorithm of the rendering rule in the related art.

Operation S102: acquire a sample volume texture of a sample map generated by the first rendering rule, and determine, based on the sample volume texture, an actual rendering value of the sample map in a sample environment configuration and reference depth data of the sample map.

In this embodiment of this disclosure, the computer device may acquire reference attributes for the sample map and further acquire, based on a virtual light source elevation angle included in the reference attributes and the sample map, the sample volume texture generated by the first rendering rule and matched with the virtual light source elevation angle. Then, the computer device may acquire a preset depth data set including N pieces of initial depth data and obtain sliced data of the sample volume texture at the virtual light source elevation angle based on the N pieces of initial depth data and the sample volume texture. The sliced data herein may include N sample sub-images. N is a positive integer, and one sample sub-image corresponds to one piece of initial depth data. In this case, the computer device may determine, from the N sample sub-images, a reference image of the sample map at the virtual light source elevation angle, and may further use a rendering value of the reference image as the actual rendering value of the sample map in the sample environment configuration and use the initial depth data of the reference image as the reference depth data.

The reference attributes acquired by the computer device may be virtual light source elevation angles pre-configured by the computer device. For example, the virtual light source elevation angles are configured as 0 degree and 10 degrees by default. The reference attributes may alternatively be virtual light source elevation angles configured by a service object (for example, a user) corresponding to the computer device on a service configuration interface of an atmospheric rendering component according to an actual requirement. This is not limited herein. The service configuration interface herein refers to a display interface configured to configure various attributes of scattering simulation rendering. For example, the service configuration interface may include a configuration control configured to configure the virtual light source elevation angle (for example, the solar elevation angle), may include a configuration control configured to input rendering parameters, and may further include a configuration control configured to configure other attributes. This is not limited herein.

For ease of understanding, in this embodiment of this disclosure, an implementation in which the computer device acquires the reference attributes for the sample map may be described by taking a configuration by a user as an example. For example, the computer device may display a service configuration interface for an atmospheric rendering component (for example, a SkyAtmosphere component in a UE4 engine) in a service engine. The service configuration interface herein may include a configuration control for the solar elevation angle.

An angle interval of the solar elevation angle may include a first angle threshold and a second angle threshold. After the sun sinks below the horizontal line, scattering phenomena exist. Therefore, the first angle threshold of the solar elevation angle in this embodiment of this disclosure may be a negative value, for example, −10 degrees. The second angle threshold may be an angle value configured for simulating noon, for example, 90 degrees. Therefore, the angle interval of the solar elevation angle may be [−10°, 90°]. The solar elevation angle herein refers to an elevation angle corresponding to directional light emitted by the sun, i.e., an included angle between the sunlight and the horizontal line.

In this case, the service object corresponding to the computer device may perform an attribute addition operation on the configuration control of the reference attribute. In other words, the service object may randomly add one or more solar elevation angles to the angle interval of the solar elevation angles, for example, sequentially adding a plurality of solar elevation angles such as −5 degrees, 0 degree, 10 degrees, and 45 degrees. This is not limited herein. The attribute addition operation herein is a trigger operation of the service object to add the solar elevation angle. The trigger operation may include a contact operation such as clicking and long pressing and may include a non-contact operation such as a voice or a gesture. This is not limited herein.

In some embodiments, the computer device may respond to the attribute addition operation, acquire a first elevation angle configured for exporting a first sample volume texture, i.e., acquiring a first elevation angle configured for exporting a volume texture that simulates daytime in the sample environment configuration, and acquire a second elevation angle configured for exporting a second sample volume texture, i.e., acquiring a second elevation angle configured for exporting a volume texture that simulates sunset in the sample environment configuration. The first sample volume texture and the second sample volume texture herein both belong to the sample volume texture, and the first elevation angle is greater than the second elevation angle. In some embodiments, the computer device may use the first elevation angle and the second elevation angle as the reference attributes for the sample map.

Then, the computer device may further acquire, based on the solar elevation angle included in the reference attributes, the sample volume texture generated by the first rendering rule and matched with the solar elevation angle. For example, if the reference attributes include four solar elevation angles: −5 degrees, 0 degree, 10 degrees, and 45 degrees, the computer device may acquire four sample volume textures generated by the first rendering rule, including a sample volume texture with the solar elevation angle of −5 degrees, for example, a sample volume texture T₁; a sample volume texture with a solar elevation angle of 0 degree, for example, a sample volume texture T₂; a sample volume texture with a solar elevation angle of 10 degree, for example, a sample volume texture T₃; and a sample volume texture with a solar elevation angle of 45 degrees, for example, a sample volume texture T₄. In this way, after training the initial rendering parameter in the second rendering rule by combining the first rendering rule and the second rendering rule, the computer device may subsequently obtain service rendering parameters corresponding to the four solar elevation angles, respectively.

In this embodiment of this disclosure, the atmospheric rendering component (for example, the SkyAtmosphere component) in the service engine may be reformed, that is, a function of exporting intermediate data is added to the SkyAtmosphere component. For example, a function of exporting the sample volume texture may be added to the SkyAtmosphere component. In addition, a function of exporting a parameter g) is further added to the Sky Atmosphere component, that is, a function of exporting a parameter configured for controlling the Mie scattering anisotropy is added.

For ease of understanding, in this embodiment of this disclosure, a virtual light source elevation angle (for example, the virtual light source elevation angle is 0 degree) may be used as an example to explain a parameter training process in the second rendering rule. In other words, the sample volume texture generated by the first rendering rule and matched with the virtual light source elevation angle includes a sample volume texture when the virtual light source elevation angle is 0 degree. The sample volume texture may be a 3D Volume texture obtained after the computer device performs texture sampling on the sample map using a vertex texture fetch (VFT) method in the second rendering rule.

Therefore, when acquiring the preset depth data set including the N pieces of initial depth data, the computer device can obtain the sliced data of the sample volume texture at the virtual light source elevation angle through the N pieces of initial depth data and the sample volume texture. The sliced data may include N sample sub-images (i.e., N slices), a parameter g, a directional light vector corresponding to a virtual light source, and initial depth data corresponding to the slices. For example, the computer device may generate a texture grid of a sample sub-image corresponding to a piece of initial depth data by running a script, for example, a python script.

In some embodiments, the computer device needs to determine, from the N sample sub-images, the reference image of the sample map at the virtual light source elevation angle. The computer device may traverse the N sample sub-images, determine a traversed sample sub-image as a to-be-processed sub-image, and then rasterize a texture grid of the to-be-processed sub-image to obtain coordinate positions corresponding to pixel points in the to-be-processed sub-image. In this case, the computer device may perform superimposition on pixel values of the pixel points based on the coordinate positions corresponding to the pixel points to obtain a total pixel value corresponding to the to-be-processed sub-image, and obtain N total pixel values until the traversing ends. Then, the computer device may select, from the N sample sub-images, a sample sub-image having a maximum total pixel value as the reference image of the sample map at the virtual light source elevation angle, use a rendering value of the reference image as the actual rendering value of the sample map in the sample environment configuration, and use the initial depth data of the reference image as the reference depth data.

For example, if there are three pieces of initial depth data in the preset depth data set, the initial depth data may include depth data S₁, depth data S₂, and depth data S₃. Then, the computer device may obtain a sample sub-image, for example, a sample sub-image P₁, corresponding to the depth data S₁ based on the depth data S₁ and the sample volume texture. Similarly, the computer device may further obtain a sample sub-image, for example, a sample sub-image P₂, corresponding to the depth data S₂; and a sample sub-image, for example, a sample sub-image P₃, corresponding to the depth data S₃. In some embodiments, the computer device may generate three sample sub-images and one data export file in a cache directory based on three sample sub-images (i.e., three slices) of the sample sub-image P₁, the sample sub-image P₂, and the sample sub-image P₃, the parameter g, the directional light vector corresponding to the virtual light source, and the initial depth data corresponding to the slices. The three sample sub-images may be stored in a tga format, and the data export file may be stored in a json format. In addition, the data export file may include the parameter g, the directional light vector corresponding to the virtual light source, and the initial depth data corresponding to the slices.

Then, the computer device may automatically run a script, such as a Python script, through the service engine, and rasterize a texture grid of each sample sub-image using a rasterization tool, such as NvDiffras, to obtain a total pixel value corresponding to each sample sub-image. For example, the computer device may rasterize a texture grid of the sample sub-image P₁ to obtain coordinate positions corresponding to the pixel points in the sample sub-image P₁, and then perform superimposition on pixel values of the pixel points based on the coordinate positions corresponding to the pixel points to obtain a total pixel value corresponding to the sample sub-image P₁. The superimposition herein may refer to first determining products of color values (for example, RGB values) and weights corresponding to the pixel points in the sample sub-image P₁, and then summing these products. Similarly, the computer device may further obtain a total pixel value corresponding to the sample sub-image P₂ and a total pixel value corresponding to the sample sub-image P₃.

In this case, the computer device may determine the maximum total pixel value from the total pixel value corresponding to the sample sub-image P₁, the total pixel value corresponding to the sample sub-image P₂, and the total pixel value corresponding to the sample sub-image P₃, and then determine the sample sub-image (for example, the sample sub-image P₃) having the maximum total pixel value as the reference image of the sample map at the virtual light source elevation angle. Then the computer device may use a rendering value of the sample sub-image P₃ as the actual rendering value of the sample map in the sample environment configuration and use the depth data S₃ as the reference depth data.

Operation S103: determine a predicted rendering value of the sample map in the sample environment configuration based on an initial rendering parameter in the second rendering rule and the reference depth data.

The initial rendering parameter herein may include a first scattering parameter, a second scattering parameter, and a luminance parameter. The first scattering parameter and the second scattering parameter correspond to different scattering manners, respectively. The luminance parameter may be configured for indicating virtual light source luminance. The sample volume texture herein is the volume texture generated by the first rendering rule and matched with the virtual light source elevation angle. The computer device may acquire an initial rendering value of the sample map, and then determine transmittance corresponding to the sample map based on an initial scattering coefficient of the first scattering parameter, an initial scattering coefficient of the second scattering parameter, and the reference depth data. In some embodiments, the computer device may determine an internal scattering parameter of the sample map at the virtual light source elevation angle based on the initial scattering coefficient of the first scattering parameter, the initial scattering coefficient of the second scattering parameter, the luminance parameter, and the reference depth data, and then determine the predicted rendering value of the sample map in the sample environment configuration based on the initial rendering value, the transmittance, and the internal scattering parameter.

In this embodiment of this disclosure, a manner in which the computer device determines a rendering value of a map may refer to the following formula (5) to formula (9):

$$L ( s , θ ) = {L}_{0} {F}_{ex} ( s ) + {L}_{i n} ( s , θ ) , \qquad ( 5 )$$

$${F}_{e x} ( s ) = {e}^{- {( {β}_{R} + {β}_{M} )}_{s}} , \qquad ( 6 )$$

$${L}_{i n} ( s , θ ) = \frac{{β}_{R} ( θ ) + {β}_{M} ( θ )}{{β}_{R} + {β}_{M}} {E}_{s u n} ( 1 - {e}^{- ( {β}_{R} + {β}_{M} ) s} ) , \qquad ( 7 )$$

$${β}_{R} ( θ ) = \frac{3}{16 π} {β}_{R} ( 1 + cos θ ) , \qquad ( 8 )$$

$${β}_{M} ( θ ) = \frac{1}{4 π} {β}_{M} \frac{{( 1 - g )}^{2}}{{( 1 + {g}^{2} - 2 g cos ( θ ) )}^{\frac{3}{2}}} ( 1 + cos θ ) , \qquad ( 9 )$$

where L₀ represents an initial rendering value of a map, i.e., representing an object color in a scene, and may be 0 by default during first training; Fₑₓ(s) represents the transmittance and refers to a proportion of light left in a phenomenon that light transmitted to the line of sight is scattered and propagates out of the line of sight; Lᵢₙ(s, θ) represents the internal scattering parameter, i.e., scattering of light outside the line of sight into the line of sight, which is also referred to as internal scattering; β_{R} represents the first scattering parameter, i.e., a scattering coefficient of the first scattering (for example, the Rayleigh scattering); β_{M} represents the second scattering parameter, i.e., a scattering coefficient of the second scattering (for example, the Mie scattering); s refers to a distance between a current observation point and a target point; θ is configured for representing an included angle between the directional light emitted by the virtual light source and the current line of sight; Eₛᵤₙ is configured for representing the luminance parameter and indicating the virtual light source luminance, for example, sunlight luminance, and may be stored in a form of an RGB color; and g is configured for representing a parameter for controlling anisotropy of the Mie scattering and may be 0.8 by default.

In this embodiment of this disclosure, the computer device may set initial values of the first scattering parameter, the second scattering parameter, and the luminance parameter in the initial rendering parameter to 1, i.e., the initial scattering coefficient of the first scattering parameter is 1, the initial scattering coefficient of the second scattering parameter is 1, and the initial value of the luminance parameter is 1. Therefore, when determining the predicted rendering value of the sample map in the sample environment configuration, the computer device may first determine the transmittance corresponding to the sample map according to the foregoing formula (6), the initial scattering coefficient (for example, 1) of the first scattering parameter, the initial scattering coefficient (for example, 1) of the second scattering parameter, and the reference depth data. Then, since the virtual light source elevation angle refers to an elevation angle corresponding to the directional light emitted by the virtual light source, the computer device needs to determine an included angle between the directional light emitted by the virtual light source and the current line of sight, then determine an updated scattering coefficient of the first scattering parameter based on the formula (8), the initial scattering coefficient of the first scattering parameter, and the included angle, and determine an updated scattering coefficient of the second scattering parameter based on the formula (9), the initial scattering coefficient of the second scattering parameter, and the included angle. Then, the computer device may determine the internal scattering parameter of the sample map at the virtual light source elevation angle based on the foregoing formula (7), the initial scattering coefficient of the first scattering parameter, the updated scattering coefficient of the first scattering parameter, the initial scattering coefficient of the second scattering parameter, the updated scattering coefficient of the second scattering parameter, the luminance parameter, and the reference depth data. Finally, the computer device may determine a product between the initial rendering value of the sample map and the transmittance based on the foregoing formula (5), and then use a sum of the determined product and the internal scattering parameter as the predicted rendering value of the sample map in the sample environment configuration.

Operation S104: train the initial rendering parameter based on the predicted rendering value and the actual rendering value to obtain a service rendering parameter matching the sample environment configuration.

In this embodiment of this disclosure, the computer device may determine a total rendering loss corresponding to the sample map based on the predicted rendering value and the actual rendering value, and then perform iterative training on the initial rendering parameter based on the total rendering loss to obtain a parameter training result. The computer device may determine, if the parameter training result indicates that an initial rendering parameter obtained after the iterative training satisfies a training cut-off condition, the initial rendering parameter that satisfies the training cut-off condition as the service rendering parameter matching the sample environment configuration. The service rendering parameter may be configured for rendering a medium scattering effect of a first map. A service environment configuration of the first map is the sample environment configuration.

In this embodiment of this disclosure, a manner in which the computer device determines the total rendering loss based on a loss function, such as a mean squared error (MSE) function, of the initial rendering parameter may refer to the following formula (10):

$$Loss = M S E = \frac{{\sum }_{i = 1}^{M} {( Y - {y}_{i} )}^{2}}{M} , \qquad ( 10 )$$

where M represents a total number of pixel points in a map, and M is a positive integer; Yᵢ is configured for representing a predicted rendering value of an i-th pixel point (for example, a pixel point Xᵢ) in the map; yᵢ represents an actual rendering value of the pixel point Xᵢ.

If the sample map includes M pixel points, and the M pixel points include the pixel point Xᵢ, M being a positive integer, and i being a positive integer less than or equal to M, the computer device may first acquire the predicted rendering value Yᵢ of the pixel point Xᵢ from the predicted rendering value, and then acquire the actual rendering value yᵢ of the pixel point Xᵢ from the actual rendering value. Then, the computer device may use a rendering difference between the predicted rendering value Yᵢ and the actual rendering value yᵢ as a rendering loss of the pixel point Xᵢ until rendering losses corresponding to the M pixel points are obtained. At this time, the computer device may determine the total rendering loss corresponding to the sample map based on the foregoing formula (10) and the M rendering losses.

In an implementation process, the computer device may acquire the training cut-off condition associated with the initial rendering parameter. The training cut-off condition may be that the total rendering loss does not continue to decrease after multiple rounds (for example, 10 rounds), that is, parameter training is stopped. In some embodiments, the training cut-off condition may alternatively be that the total rendering loss is less than or equal to a loss threshold in the training cut-off condition, for example, the loss threshold may be 0.01, i.e., parameter training is stopped. Alternatively, in some other embodiments, the training cut-off condition may alternatively be that the total rendering loss is less than or equal to the loss threshold in the training cut-off condition, and training duration is greater than a training duration threshold in the training cut-off condition, i.e., parameter training is stopped.

The computer device may use, if the parameter training result indicates that the initial rendering parameter obtained after the iterative training satisfies the training cut-off condition, the initial rendering parameter that satisfies the training cut-off condition as the service rendering parameter matching the sample environment configuration. In some embodiments, the computer device may perform, if the parameter training result indicates that the initial rendering parameter obtained after the iterative training does not satisfy the training cut-off condition, parameter adjustment on the initial rendering parameter based on the total rendering loss that does not satisfy the training cut-off condition. In some embodiments, the computer device may use the adjusted initial rendering parameter as a transition rendering parameter, perform iterative training on the transition rendering parameter, and use, until a transition rendering parameter obtained after the iterative training satisfies the training cut-off condition, the transition rendering parameter that satisfies the training cut-off condition as the service rendering parameter matching the sample environment configuration.

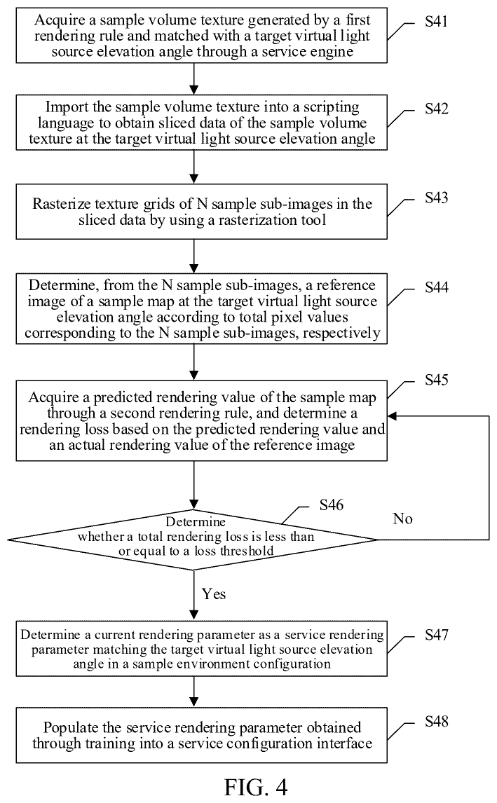

In some embodiments, referring to FIG. 4, FIG. 4 is a schematic flowchart of a training parameter according to an embodiment of this disclosure. As shown in FIG. 4, the schematic flowchart in this embodiment of this disclosure may include operation S41 to operation S48. Specifically, a virtual light source elevation angle Φ (i.e., a target virtual light source elevation angle, for example, Φ is 10 degrees) in a sample configuration environment is used as an example to describe a process of training a rendering parameter matching the target virtual light source elevation angle by combining the first rendering rule and the second rendering rule.

Operation S41: acquire a sample volume texture generated by a first rendering rule and matched with a target virtual light source elevation angle through a service engine.

Operation S42: import the sample volume texture into a scripting language to obtain sliced data of the sample volume texture at the target virtual light source elevation angle.

For example, the sample volume texture is imported into a Python scripting language to obtain sliced data of the sample volume texture at the target virtual light source elevation angle based on N pieces of initial depth data in a preset depth data set and the sample volume texture. The sliced data herein may include N sample sub-images (i.e., N slices), a parameter g, a directional light vector corresponding to a virtual light source, and initial depth data corresponding to the slices.

Operation S43: rasterize texture grids of the N sample sub-images in the sliced data using a rasterization tool.

For example, the texture grids of the N sample sub-images in the sliced data are rasterized using NvDiffras to obtain total pixel values corresponding to the sample sub-images.

Operation S44: determine, from the N sample sub-images, a reference image of a sample map at the target virtual light source elevation angle according to the total pixel values corresponding to the N sample sub-images, respectively.

Herein, a sample sub-image having a maximum total pixel value may be selected as the reference image of the sample map at the virtual light source elevation angle. A rendering value of the reference image herein may be used as an actual rendering value of the sample map at the target virtual light source elevation angle in a sample environment configuration. Initial depth data of the reference image may be used as reference depth data of the sample map at the target virtual light source elevation angle in the sample environment configuration.

Operation S45: acquire a predicted rendering value of the sample map through a second rendering rule, and determine a rendering loss based on the predicted rendering value and an actual rendering value of the reference image.

Herein, the predicted rendering value of the sample map may be acquired according to the foregoing formula (5) to formula (10) and the second rendering rule, and the rendering loss may be determined based on the predicted rendering value and the actual rendering value of the reference image. For example, the computer device may determine the predicted rendering value of the sample map at the target virtual light source elevation angle according to the foregoing formula (5) to formula (9), the initial rendering parameter (β_{R}, β_{M}, and Eₛᵤₙ) in the second rendering rule, an included angle (θ) between directional light and a current line of sight, and the reference depth data(s) corresponding to the reference image, and then may determine the total rendering loss corresponding to the sample map based on the foregoing formula (10), the predicted rendering value, and the actual rendering value.

Operation S46: determine whether the total rendering loss is less than or equal to a loss threshold.

If a determining result is yes, operation S47 is performed. That is, if the total rendering loss is less than or equal to the loss threshold, the computer device may determine that the initial rendering parameter satisfies a training cut-off condition, and then operation S47 may be performed, i.e., directly determining the initial rendering parameter as a service rendering parameter matching the target virtual light source elevation angle in the sample environment configuration.

If the determining result is no, the process returns to operation S45. That is, if the total rendering loss is greater than the loss threshold, the computer device may adjust the initial rendering parameter, then perform operation S46 again, re-determine a predicted rendering value of the sample map, determine a new total rendering loss based on the re-determined predicted rendering value and the actual rendering value to continue to compare the new total rendering loss with the loss threshold, and until the new total rendering loss is less than or equal to the loss threshold, continue to perform the following operation S47.

Operation S47: determine a current rendering parameter as the service rendering parameter matching the target virtual light source elevation angle in the sample environment configuration.

Operation S48: populate the service rendering parameter obtained through training into a service configuration interface.

The service rendering parameter herein is trained β_{R}, β_{M}, and Eₛᵤₙ, and the trained β_{R}, β_{M}, and Eₛᵤₙ may be populated into corresponding attributes of a Sky Atmosphere component. That is, the trained β_{R}, β_{M}, and Eₛᵤₙ are imported into the service engine so that the service rendering parameter may be directly applied when a medium scattering effect of a map is subsequently rendered at the target virtual light source elevation angle in the sample environment configuration. In this embodiment of this disclosure, a vertex shader in the SkyAtmosphere component may be reformed, that is, an air perspective rendering algorithm of the second rendering rule may be integrated. In a rendering process, air perspective may be efficiently calculated on a low-end device in real time using the second rendering rule in conjunction with a scene object color L₀. Meanwhile, the computer device may further use its original sky drawing scheme, i.e., rendering the sky effect through the first rendering rule.

In addition, the service rendering parameter herein may be a rendering parameter corresponding to the target virtual light source elevation angle in the sample environment configuration, and the target virtual light source elevation angle belongs to Z virtual light source elevation angles, where Z is a positive integer greater than 1. The Z virtual light source elevation angles are acquired when the computer device responds to an attribute addition operation. The attribute addition operation herein is a trigger operation performed on a configuration control of the reference attribute. A larger number of virtual light source elevation angles indicates a larger number of data fitting points for a service distribution diagram, thereby leading to higher accuracy of a service rendering distribution diagram obtained through fitting. Each rendering parameter includes a first scattering parameter, a second scattering parameter, and a luminance parameter. This means that the computer device may refer to the foregoing training manner for the service rendering parameter of the target virtual light source elevation angle to acquire rendering parameters corresponding to the Z virtual light source elevation angles.

In some embodiments, the computer device may determine, from Z rendering parameters, Z scattering coefficients associated with the first scattering parameters and fit determined Z scattering coefficients within an angle interval of the virtual light source elevation angle to obtain a first rendering distribution diagram associated with the first scattering parameters. Similarly, the computer device may further determine, from the Z rendering parameters, Z scattering coefficients associated with the second scattering parameters and fit determined Z scattering coefficients within the angle interval of the virtual light source elevation angle to obtain a second rendering distribution diagram associated with the second scattering parameters. Meanwhile, the computer device may also determine, from the Z rendering parameters, Z pieces of virtual light source luminance associated with the luminance parameters and fit determined Z pieces of virtual light source luminance within the angle interval of the virtual light source elevation angle to obtain a third rendering distribution diagram associated with the luminance parameters. In this case, the computer device may determine the first rendering distribution diagram, the second rendering distribution diagram, and the third rendering distribution diagram as a service rendering distribution diagram matching the sample environment configuration.

For example, if the virtual light source elevation angle is Φ₁, a rendering parameter corresponding to the virtual light source elevation angle Φ₁ may include a first scattering parameter (represented by β_{R1}), a second scattering parameter (represented by β_{M1}), and a luminance parameter (represented by Eₛᵤₙ₁). If the virtual light source elevation angle is Φ₂, a rendering parameter corresponding to the virtual light source elevation angle Φ₂ may include a first scattering parameter (represented by β_{R2}), a second scattering parameter (represented by β_{M2}), and a luminance parameter (represented by Eₛᵤₙ₂). The rest may be deduced by analogy. When fitting the first rendering distribution diagram associated with the first scattering parameters, the computer device may acquire Z data fitting points that may include a data fitting point 1, represented as: (Φ₁, β_{R1}), a data fitting point 2, represented as: (Φ₂, β_{R2}), . . . , and a data fitting point Z, represented as: (Φ_{Z}, β_{RZ}). Then, the computer device may fit the Z data fitting points within the angle interval of the virtual light source elevation angle to obtain the first rendering distribution diagram. That is, the first rendering distribution diagram may be a distribution diagram in which the virtual light source elevation angle Φ is used as a horizontal coordinate, and the first scattering parameter is used as a vertical coordinate.

When fitting the second rendering distribution diagram associated with the second scattering parameters, the computer device may acquire Z data fitting points that may include a data fitting point 1, represented as: (Φ₁, β_{M1}), a data fitting point 2, represented as: (Φ₂, β_{M2}), . . . , and a data fitting point Z, represented as: (Φ_{Z}, β_{MZ}). Then, the computer device may fit the Z data fitting points within the angle interval of the virtual light source elevation angle to obtain the second rendering distribution diagram. That is, the second rendering distribution diagram may be a distribution diagram in which the virtual light source elevation angle Φ is used as a horizontal coordinate, and the second scattering parameter is used as a vertical coordinate.

When fitting the third rendering distribution diagram associated with the luminance parameters, the computer device may acquire Z data fitting points that may include a data fitting point 1, represented as: (Φ₁, Eₛᵤₙ₁), a data fitting point 2, represented as: (Φ₂, Eₛᵤₙ₂), . . . , and a data fitting point Z, represented as: (Φ_{Z}, Eₛᵤₙ₂). Then, the computer device may fit the Z data fitting points within the angle interval of the virtual light source elevation angle to obtain the third rendering distribution diagram. That is, the third rendering distribution diagram may be a distribution diagram in which the virtual light source elevation angle Φ is used as a horizontal coordinate, and the luminance parameter (Eₛᵤₙ) is used as a vertical coordinate.

In some embodiments, the computer device may determine the first rendering distribution diagram, the second rendering distribution diagram, and the third rendering distribution diagram as the service rendering distribution diagram matching the sample environment configuration so that a rendering parameter corresponding to a virtual light source elevation angle in the sample environment configuration can be quickly read subsequently, and a medium scattering effect of any map in the sample environment configuration may be rendered in real time, thereby improving the rendering efficiency.

It can be seen that in this embodiment of this disclosure, the initial rendering parameter in the second rendering rule does not need to be manually adjusted, but intermediate data of the new physical algorithm of the first rendering rule may be directly acquired, that is, the sample volume texture of the new physical algorithm of the first rendering rule may be directly acquired, to deduce the hard-to-adjust rendering parameter in the second rendering rule. This means that in the embodiments of this disclosure, when the medium scattering effect is rendered, the second rendering rule is not directly used, but the first rendering rule and the second rendering rule are combined to more quickly and accurately obtain the service rendering parameter. In this way, when the medium scattering effect of the first map is rendered subsequently, not only the rendering effect may be ensured, but also the rendering efficiency may be improved. That is, the scattering simulation method used in the embodiments of this disclosure may take both the rendering effect and the rendering efficiency into consideration.

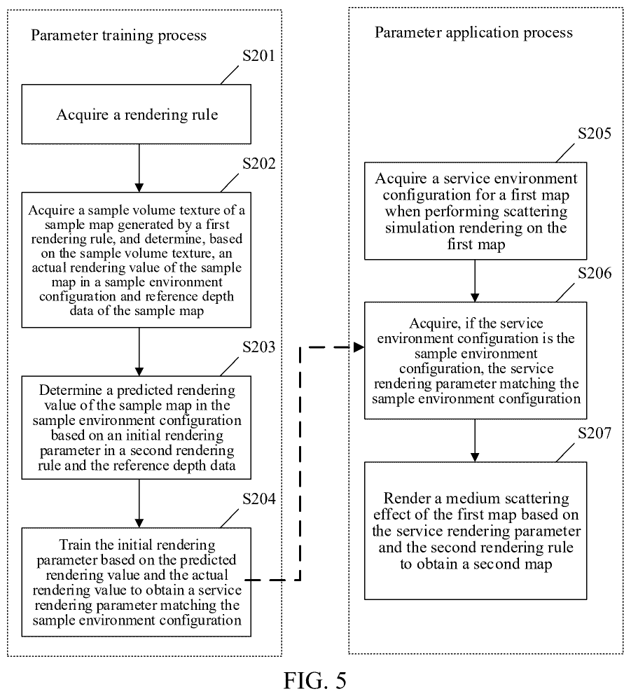

In some embodiments, referring to FIG. 5, FIG. 5 is a schematic flowchart of another data processing method according to an embodiment of this disclosure. The method may be performed by a terminal device having a rendering function, for example, performed by any terminal device, for example, the terminal device 100a, in the terminal device cluster shown in FIG. 1, or may be performed by a server having a rendering function, for example, performed by the server 10F shown in FIG. 1, or may be performed interactively by a terminal device having a parameter application function and a server having a parameter training function. This is not limited herein. The method may include at least the following operation S201 to operation S207.

Operation S201: acquire a rendering rule.

The rendering rule herein includes a first rendering rule and a second rendering rule. The first rendering rule may be configured for rendering a virtual scene containing a medium. The second rendering rule may be configured for rendering a medium scattering effect.

Operation S202: acquire a sample volume texture of a sample map generated by the first rendering rule, and determine, based on the sample volume texture, an actual rendering value of the sample map in a sample environment configuration and reference depth data of the sample map.

In this embodiment of this disclosure, the computer device may acquire reference attributes for the sample map and further acquire, based on a virtual light source elevation angle included in the reference attributes and the sample map, the sample volume texture generated by the first rendering rule and matched with the virtual light source elevation angle. Then, the computer device may acquire a preset depth data set including N pieces of initial depth data and obtain sliced data of the sample volume texture at the virtual light source elevation angle based on the N pieces of initial depth data and the sample volume texture. The sliced data herein may include N sample sub-images. N is a positive integer. In this case, the computer device may determine, from the N sample sub-images, a reference image of the sample map at the virtual light source elevation angle, and may further use a rendering value of the reference image as the actual rendering value of the sample map in the sample environment configuration and use the initial depth data of the reference image as the reference depth data.

Operation S203: determine a predicted rendering value of the sample map in the sample environment configuration based on an initial rendering parameter in the second rendering rule and the reference depth data.

The initial rendering parameter herein may include a first scattering parameter, a second scattering parameter, and a luminance parameter. The first scattering parameter and the second scattering parameter correspond to different scattering manners, respectively. The luminance parameter may be configured for indicating virtual light source luminance. The actual rendering value is a rendering value corresponding to a reference image of the sample map. In this embodiment of this disclosure, the computer device may acquire an initial rendering value of the sample map, and then determine transmittance corresponding to the sample map based on an initial scattering coefficient of the first scattering parameter, an initial scattering coefficient of the second scattering parameter, and the reference depth data. In some embodiments, the computer device may determine an internal scattering parameter of the sample map at the virtual light source elevation angle based on the initial scattering coefficient of the first scattering parameter, the initial scattering coefficient of the second scattering parameter, the luminance parameter, the reference depth data, and the virtual light source elevation angle corresponding to the reference image, and then determine the predicted rendering value of the sample map in the sample environment configuration based on the initial rendering value, the transmittance, and the internal scattering parameter.

Operation S204: train the initial rendering parameter based on the predicted rendering value and the actual rendering value to obtain a service rendering parameter matching the sample environment configuration.

In this embodiment of this disclosure, the computer device may determine a total rendering loss corresponding to the sample map based on the predicted rendering value and the actual rendering value, and then perform iterative training on the initial rendering parameter based on the total rendering loss to obtain a parameter training result. The computer device may determine, if the parameter training result indicates that an initial rendering parameter obtained after the iterative training satisfies a training cut-off condition, the initial rendering parameter that satisfies the training cut-off condition as the service rendering parameter matching the sample environment configuration. The service rendering parameter may be configured for rendering a medium scattering effect of a first map. A service environment configuration of the first map is the sample environment configuration.

The data processing method in this embodiment of this disclosure may include a parameter training process and a parameter application process. Operation S201 to operation S204 describe the parameter training process. An implementation of the parameter training process may refer to the descriptions of operation S101 to operation S104 in the foregoing embodiment corresponding to FIG. 3. Details are not further described herein again.

The parameter application process may refer to the descriptions of the following operation S205 to operation S207.

Operation S205: acquire a service environment configuration for a first map when performing scattering simulation rendering on the first map.

In this embodiment of this disclosure, when performing scattering simulation rendering on the first map, the computer device needs to acquire the service environment configuration for the first map, and then search, in a database storing sample environment configuration, whether the service environment configuration is a sample environment configuration already stored in the database.

Operation S206: acquire, if the service environment configuration is the sample environment configuration, a service rendering parameter matching the sample environment configuration.

The service rendering parameter is obtained after training the initial rendering parameter in the second rendering rule based on the predicted rendering value and the actual rendering value of the sample map in the sample environment configuration. The actual rendering value of the sample map is determined based on the sample volume texture of the sample map. The sample volume texture of the sample map is generated by the first rendering rule. The first rendering rule is configured for rendering the virtual scene containing a medium. The second rendering rule is configured for rendering the medium scattering effect. In this embodiment of this disclosure, when the sample environment configuration is stored into the database, if the service environment configuration is the sample environment configuration, the computer device may search the database for a service rendering distribution diagram matching the sample environment configuration based on an association relationship of the sample environment configuration. The service rendering distribution diagram herein may include a first rendering distribution diagram associated with first scattering parameters, a second rendering distribution diagram associated with second scattering parameters, and a third rendering distribution diagram associated with luminance parameters. In some embodiments, the computer device needs to determine a to-be-rendered angle corresponding to the first map, then determines, in the first rendering distribution diagram, a scattering coefficient corresponding to the to-be-rendered angle as a first to-be-processed coefficient, determines, in the second rendering distribution diagram, a scattering coefficient corresponding to the to-be-rendered angle as a second to-be-processed coefficient, determines, in the third rendering distribution diagram, virtual light source luminance corresponding to the to-be-rendered angle as to-be-processed luminance, and may further determine the first to-be-processed coefficient, the second to-be-processed coefficient, and the to-be-processed luminance as the service rendering parameter matching the sample environment configuration.

In some embodiments, if the database does not have a sample environment configuration matching the service environment configuration, the computer device may use the service environment configuration as an updated sample configuration (i.e., a new sample environment configuration) and use the first map as an updated sample map (i.e., a new sample map) in the updated sample configuration. In some embodiments, the computer device may acquire a sample volume texture of the updated sample map generated by the first rendering rule, determine an actual rendering value of the updated sample map in the updated sample configuration and reference depth data of the updated sample map based on the sample volume texture of the updated sample map, and further determine a predicted rendering value of the updated sample map in the updated sample configuration through the initial rendering parameter in the second rendering rule and the reference depth data of the updated sample map. Then, the computer device may train the initial rendering parameter based on the actual rendering value of the updated sample map in the updated sample configuration and the predicted rendering value of the updated sample map in the updated sample configuration to obtain an updated rendering parameter matching the updated sample configuration, and may further store the updated sample configuration into the database based on the updated rendering parameter.

Operation S207: render a medium scattering effect of the first map based on the service rendering parameter and the second rendering rule to obtain a second map.

The service rendering parameter herein may include rendering parameters corresponding to a plurality of to-be-rendered angles. In this embodiment of this disclosure, the computer device may render the medium scattering effect of the first map with reference to the second rendering rule shown in the foregoing formula (5) to formula (9) and the rendering parameters at the to-be-rendered angles to obtain second maps matching the to-be-rendered angles. When the to-be-rendered angles are successively changed from a first angle threshold to a second angle threshold, the computer device may acquire a plurality of second maps to render the medium scattering effect of the first map in real time.

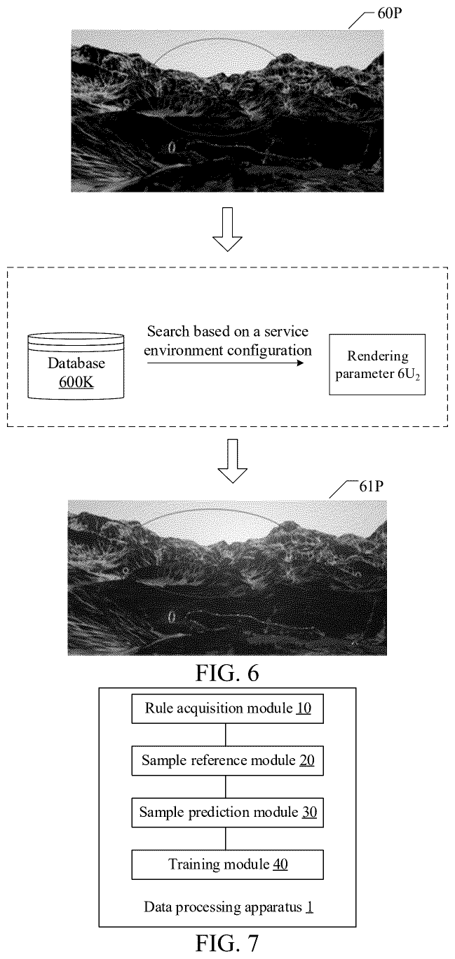

For ease of understanding, in some embodiments, referring to FIG. 6, FIG. 6 is a schematic diagram of a scene for rendering a medium scattering effect according to an embodiment of this disclosure. As shown in FIG. 6, a map 60P may be a map (i.e., a first map) acquired by a computer device in this embodiment of this disclosure that needs to be rendered for a medium scattering effect (e.g., an aerial perspective effect). The map 60P may be an original map on which scattering simulation rendering is not performed, or may be a map obtained after simulation rendering is already performed on a medium-containing virtual scene (for example, a sky effect) of the original map. This is not limited herein.

As shown in FIG. 6, the database 600K may store a service rendering parameter that is trained by the computer device and matches a sample environment configuration. For example, the database 600K may store a relationship table configured for indicating an association relationship of the sample environment configuration. The relationship table may include a plurality of sample environment configurations. For ease of description, in this embodiment of this disclosure, two sample environment configurations may be used as an example and may include an environment configuration 1 (for example, the Earth) and an environment configuration 2 (for example, the Mars).

For ease of understanding, in some embodiments, referring to Table 1, Table 1 is a relationship table stored in a database according to an embodiment of this disclosure. The relationship table may include a sample environment configuration column, an actual training column, and a service rendering distribution diagram column. Certainly, the relationship table may further include other columns. This is not limited herein. The training column herein refers to rendering parameters at the virtual light source elevation angles that are actually trained in the sample environment configuration. The following is shown in FIG. 1.

TABLE 1

| | Actual training | | |
|---|---|---|---|
| Sample | Virtual light | | Service rendering |
| environment | source | Rendering | distribution |
| configuration | elevation angle | parameter | diagram |
| Environment | 1Φ₁ (for | β_{R1}, β_{M1}, | Rendering |
| configuration 1 | example, −5°) | and Eₛᵤₙ₁ | distribution |
| (for example, | 1Φ₂ (for | β_{R2}, β_{M2}, | diagram 10F₁ |
| the earth) | example, 0°) | and Eₛᵤₙ₂ | Rendering |
| | 1Φ₃ (for | β_{R3}, β_{M3}, | distribution |
| | example, 10°) | and Eₛᵤₙ₃ | diagram 10F₂ |
| | 1Φ₄ (for | β_{R4}, β_{M4}, | Rendering |
| | example, 60°) | and Eₛᵤₙ₄ | distribution |
| | | | diagram 10F₃ |
| Environment | 2Φ₁ (for | β_{R1}, β_{M1}, | Rendering |
| configuration 2 | example, −10°) | and Eₛᵤₙ₁ | distribution |
| (for example, | 2Φ₂ (for | β_{R2}, β_{M2}, | diagram 20F₁ |
| the Mars) | example, 0°) | and Eₛᵤₙ₂ | Rendering |
| | 2Φ₃ (for | β_{R3}, β_{M3}, | distribution |
| | example, 15°) | and Eₛᵤₙ₃ | diagram 20F₂ |
| | 2Φ₄ (for | β_{R4}, β_{M4}, | Rendering |
| | example, 45°) | and Eₛᵤₙ₄ | distribution |
| | 2Φ₅ (for | β_{R5}, β_{M5}, | diagram 20F₃ |
| | example, 90°) | and Eₛᵤₙ₅ | |

Taking the environment configuration 1 as an example, when a service object performs an attribute addition operation on a configuration control of a reference attribute, a virtual light source elevation angle 1Φ₁ (for example, −5°), a virtual light source elevation angle 1Φ₂ (for example, 0°), a virtual light source elevation angle 1Φ₃ (for example, 10°), and a virtual light source elevation angle 1Φ₄ (for example, 60°) may be added. Therefore, when responding to the attribute addition operation, the computer device can acquire these four virtual light source elevation angles, and then train rendering parameters at these four virtual light source elevation angles by combining a first rendering rule and a second rendering rule to obtain the rendering parameters corresponding to the virtual light source elevation angles. In some embodiments, the computer device may perform fitting within an angle interval of the virtual light source elevation angle based on the four rendering parameters to obtain a service rendering distribution diagram matching the environment configuration 1. The service rendering distribution diagram may include a rendering distribution diagram 10F₁, a rendering distribution diagram 10F₂, and a rendering distribution diagram 10F₃. The rendering distribution diagram 10F₁ is configured for representing a first rendering distribution diagram associated with the first scattering parameter, that is, the rendering distribution diagram 10F₁ is a rendering distribution diagram associated with a scattering coefficient of Rayleigh scattering. The rendering distribution diagram 10F₂ is configured for representing a second rendering distribution diagram associated with the second scattering parameter, that is, the rendering distribution diagram 10F₂ is a rendering distribution diagram associated with a scattering coefficient of Mie scattering. The rendering distribution diagram 10F₃ is configured for representing a third rendering distribution diagram associated with the luminance parameter, that is, the rendering distribution diagram 10F₃ is configured for representing a rendering distribution diagram associated with virtual light source luminance.

When acquiring the map 60P, the computer device may determine a service environment configuration of the map 60P, and then search the database 600K based on the service environment configuration of the map 60P. If the service environment configuration of the map 60P is the sample environment configuration (for example, the environment configuration 1) included in Table 1, the computer device may directly acquire a service rendering parameter matching the environment configuration 1 according to Table 1.

If a to-be-rendered angle (for example, 10°) corresponding to the first map belongs to the virtual light source elevation angle in the actual training column corresponding to the environment configuration 1, the computer device may directly search the actual training column for a rendering parameter matching the to-be-rendered angle as the service rendering parameter. For another example, if the to-be-rendered angle (for example, 20°) does not belong to the virtual light source elevation angle in the actual training column corresponding to the environment configuration 1, when a rendering accuracy requirement is relatively low, the computer device may rapidly search three rendering distribution diagrams of the service rendering distribution diagram matching the environment configuration 1 for a rendering parameter matching the to-be-rendered angle as the service rendering parameter. For example, the computer device may search the rendering distribution diagram 10F₁ for a scattering coefficient corresponding to the to-be-rendered angle, search the rendering distribution diagram 10F₂ for a scattering coefficient corresponding to the to-be-rendered angle, search the rendering distribution diagram 10F₃ for virtual light source luminance corresponding to the to-be-rendered angle, and then use the three determined parameters as the service rendering parameter matching the sample environment configuration. Certainly, since the service rendering parameter at the virtual light source elevation angle of 20 degrees is read from the service rendering distribution diagram, when the rendering accuracy requirement is excessively high, the computer device may alternatively use the first map as a new sample map and retrain the service rendering parameter at the virtual light source elevation angle of 20 degrees by combining the first rendering rule and the second rendering rule. Then, the computer device may update Table 1 based on the service rendering parameter at the virtual light source elevation angle of 20 degrees.

In some embodiments, if the service environment configuration of the map 60P is the environment configuration 3 (for example, the moon), there is no sample environment configuration matching the environment configuration 3 in Table 1 stored in the database 600K, which means that the computer device cannot acquire the service rendering parameter matching the environment configuration 3 according to Table 1. In this case, the computer device may use the first map as a new sample map and retrain the service rendering parameter matching the environment configuration 3 by combining the first rendering rule and the second rendering rule.

For example, the computer device may use the environment configuration 3 as an updated sample configuration (i.e., a new sample environment configuration) and use the first map as an updated sample map (i.e., a new sample map) in the updated sample configuration. Then, the initial rendering parameter of the updated sample configuration is trained with reference to the foregoing parameter training method for the sample environment configuration to obtain the updated rendering parameter matching the updated sample configuration. Further, an association relationship among the environment configuration 3, a rendering parameter at the virtual light source elevation angle in actual training, and the service rendering distribution diagram matching the environment configuration 3 may be established and stored in Table 1 to update Table 1.

When the service rendering parameter matching the service environment configuration of the map 60P is acquired, for example, when a rendering parameter 6U₂ is acquired, the computer device may render an aerial perspective effect of the map 60P in real time according to a rendering parameter of a to-be-rendered angle included in the rendering parameters 6U₂ to obtain a second map corresponding to the to-be-rendered angle, for example, obtaining a map 61P, thereby improving the rendering efficiency. Since an atmospheric scattering algorithm is mostly a rendering algorithm of a screen space, in this embodiment of this disclosure, a particular differentiable renderer is not relied on, and even a renderer may be implemented by itself without a differentiable renderer. In this embodiment of this disclosure, an automatic differentiation function for machine learning (for example, Pytorch) of application programs such as image identification and language processing may be adopted to render an aerial perspective effect.

It can be seen that in this embodiment of this disclosure, an old simplification algorithm and a new physical algorithm may be combined to resolve a problem of efficiency of real-time rendering on a medium scattering effect of a map. A hard-to-adjust parameter in the second rendering rule is deduced using intermediate data (i.e., a 3D Volume texture) of the first rendering rule in combination with a differentiable rendering technology so that a balance of correct effect, efficient manufacturing, and rendering efficiency can be achieved in an entire scattering rendering system.

In some embodiments, referring to FIG. 7, FIG. 7 is a schematic structural diagram of a data processing apparatus according to an embodiment of this disclosure. As shown in FIG. 7, a data processing apparatus 1 may be a computer program (including a program code) running in a computer device. For example, the data processing apparatus 1 is application software. The data processing apparatus 1 may be configured to perform corresponding operations in the data processing method provided by the embodiments of this disclosure. As shown in FIG. 7, the data processing apparatus 1 may run on a computer device having a rendering function. The computer device may be the server 10F in the foregoing embodiment corresponding to FIG. 1, or may be any terminal device, for example, the terminal device 100a, in the terminal device cluster in the foregoing embodiment corresponding to FIG. 1. The data processing apparatus 1 may include: a rule acquisition module 10, a sample reference module 20, a sample prediction module 30, and a training module 40.

The rule acquisition module 10 is configured to acquire a rendering rule. The rendering rule includes a first rendering rule and a second rendering rule. The first rendering rule is configured for rendering a virtual scene containing a medium. The second rendering rule is configured for rendering a medium scattering effect. The sample reference module 20 is configured to acquire a sample volume texture of a sample map generated by the first rendering rule and determine, based on the sample volume texture, an actual rendering value of the sample map in a sample environment configuration and reference depth data of the sample map. The sample prediction module 30 is configured to determine a predicted rendering value of the sample map in the sample environment configuration based on an initial rendering parameter in the second rendering rule and the reference depth data. The training module 40 is configured to train the initial rendering parameter based on the predicted rendering value and the actual rendering value to obtain a service rendering parameter matching the sample environment configuration. The service rendering parameter is configured for rendering a medium scattering effect of a first map. A service environment configuration of the first map is the sample environment configuration.

In some embodiments, the sample reference module 20 is further configured to acquire reference attributes for the sample map; and acquire, based on a virtual light source elevation angle included in the reference attributes and the sample map, the sample volume texture generated by the first rendering rule and matched with the virtual light source elevation angle.

In some embodiments, the sample reference module 20 is further configured to acquire a preset depth data set including N pieces of initial depth data; determine sliced data of the sample volume texture at the virtual light source elevation angle based on the N pieces of initial depth data and the sample volume texture, the sliced data including N sample sub-images; and N being a positive integer; determine, from the N sample sub-images, a reference image of the sample map at the virtual light source elevation angle; and determine a rendering value of the reference image as the actual rendering value of the sample map in the sample environment configuration, and determine initial depth data of the reference image as the reference depth data.

In some embodiments, the virtual light source elevation angle includes a solar elevation angle; the sample volume texture includes a first sample volume texture and a second sample volume texture; the first sample volume texture refers to a volume texture configured for simulating daytime in the sample environment configuration; the second sample volume texture refers to a volume texture configured for simulating sunset in the sample environment configuration; and the sample reference module 20 is further configured to display a service configuration interface for an atmospheric rendering component in a service engine, the service configuration interface including a configuration control for the solar elevation angle; respond to an attribute addition operation for the configuration control, and acquire a first elevation angle configured for exporting the first sample volume texture and a second elevation angle configured for exporting the second sample volume texture, the first elevation angle being greater than the second elevation angle; and determine the first elevation angle and the second elevation angle as the reference attributes for the sample map.

In some embodiments, the sample reference module 20 is further configured to traverse the N sample sub-images, and determine a traversed sample sub-image as a to-be-processed sub-image; rasterize a texture grid of the to-be-processed sub-image to obtain coordinate positions corresponding to pixel points in the to-be-processed sub-image; perform superimposition on pixel values of the pixel points based on the coordinate positions corresponding to the pixel points to obtain a total pixel value corresponding to the to-be-processed sub-image, and obtain N total pixel values until the traversing ends; and select, from the N sample sub-images, a sample sub-image having a maximum total pixel value as the reference image of the sample map at the virtual light source elevation angle.

In some embodiments, the initial rendering parameter includes a first scattering parameter, a second scattering parameter, and a luminance parameter; the first scattering parameter and the second scattering parameter correspond to different scattering manners, respectively; the luminance parameter is configured for indicating virtual light source luminance; the sample volume texture is a volume texture generated by the first rendering rule and matched with the virtual light source elevation angle; and the sample prediction module 30 is further configured to acquire an initial rendering value of the sample map; determine transmittance corresponding to the sample map based on an initial scattering coefficient of the first scattering parameter, an initial scattering coefficient of the second scattering parameter, and the reference depth data; determine an internal scattering parameter of the sample map at the virtual light source elevation angle based on the initial scattering coefficient of the first scattering parameter, the initial scattering coefficient of the second scattering parameter, the luminance parameter, and the reference depth data; and determine the predicted rendering value of the sample map in the sample environment configuration based on the initial rendering value, the transmittance, and the internal scattering parameter.

In some embodiments, the virtual light source elevation angle refers to an elevation angle corresponding to directional light emitted by a virtual light source; and the sample prediction module 30 is further configured to determine an included angle between the directional light emitted by the virtual light source and a current line of sight; determine an updated scattering coefficient of the first scattering parameter based on the initial scattering coefficient of the first scattering parameter and the included angle; determine an updated scattering coefficient of the second scattering parameter based on the initial scattering coefficient of the second scattering parameter and the included angle; and determine the internal scattering parameter of the sample map at the virtual light source elevation angle based on the initial scattering coefficient of the first scattering parameter, the updated scattering coefficient of the first scattering parameter, the initial scattering coefficient of the second scattering parameter, the updated scattering coefficient of the second scattering parameter, the luminance parameter, and the reference depth data.

In some embodiments, the training module 40 is further configured to determine a total rendering loss of the sample map based on the predicted rendering value and the actual rendering value; perform iterative training on the initial rendering parameter based on the total rendering loss to obtain a parameter training result; and determine, if the parameter training result indicates that an initial rendering parameter obtained after the iterative training satisfies a training cut-off condition, the initial rendering parameter that satisfies the training cut-off condition as the service rendering parameter matching the sample environment configuration.

In some embodiments, the sample map includes M pixel points; M is a positive integer; the M pixel points include a pixel point Xᵢ; i is a positive integer less than or equal to M; and the training module 40 is further configured to acquire a predicted rendering value Yᵢ of the pixel point Xᵢ from the predicted rendering value, and acquire an actual rendering value yᵢ of the pixel point Xᵢ from the actual rendering value; determine a rendering difference between the predicted rendering value Yᵢ and the actual rendering value yᵢ as a rendering loss of the pixel point Xᵢ until rendering losses corresponding to the M pixel points are obtained; and determine the total rendering loss corresponding to the sample map based on M rendering losses.

In some embodiments, the service rendering parameter is a rendering parameter corresponding to a target virtual light source elevation angle in the sample environment configuration; the target virtual light source elevation angle is any one of Z virtual light source elevation angles; Z is a positive integer greater than 1; the Z virtual light source elevation angles are elevation angles acquired when responding to a trigger operation performed by the configuration control for the reference attributes; and the apparatus further includes: a rendering parameter acquisition module configured to acquire rendering parameters corresponding to the Z virtual light source elevation angles, each rendering parameter including a first scattering parameter, a second scattering parameter, and a luminance parameter; a first fitting module configured to determine, from Z rendering parameters, first scattering coefficients associated with the first scattering parameters to obtain Z first scattering coefficients; and fit determined Z first scattering coefficients within an angle interval of the virtual light source elevation angles to obtain a first rendering distribution diagram associated with the first scattering parameters; a second fitting module configured to determine, from the Z rendering parameters, second scattering coefficients associated with the second scattering parameters to obtain Z second scattering coefficients; and fit determined Z second scattering coefficients within the angle interval of the virtual light source elevation angles to obtain a second rendering distribution diagram associated with the second scattering parameters; a third fitting module configured to determine, from the Z rendering parameters, virtual light source luminance associated with the luminance parameters to obtain Z pieces of virtual light source luminance; and fit determined Z pieces of virtual light source luminance within the angle interval of the virtual light source elevation angles to obtain a third rendering distribution diagram associated with the luminance parameters; and a distribution diagram determining module configured to determine the first rendering distribution diagram, the second rendering distribution diagram, and the third rendering distribution diagram as a service rendering distribution diagram matching the sample environment configuration.

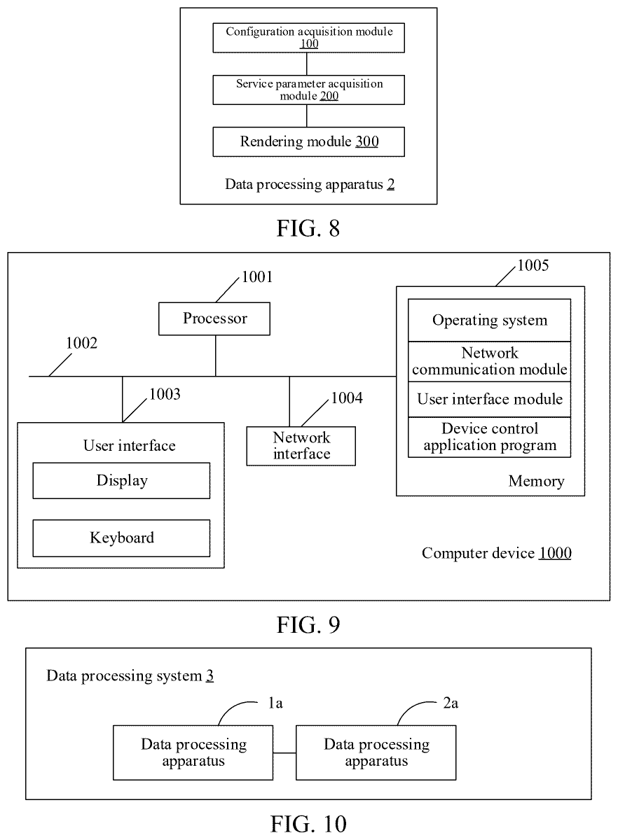

In some embodiments, referring to FIG. 8, FIG. 8 is a schematic structural diagram of another data processing apparatus according to an embodiment of this disclosure. A data processing apparatus 2 may be a computer program (including a program code) running in a computer device. For example, the data processing apparatus 2 is application software. The data processing apparatus 2 may be configured to perform corresponding operations in the method provided by the embodiments of this disclosure. As shown in FIG. 8, the data processing apparatus 2 may run on a computer device having a rendering function. The computer device may be the server 10F in the foregoing embodiment corresponding to FIG. 1, or may be any terminal device, for example, the terminal device 100a, in the terminal device cluster in the foregoing embodiment corresponding to FIG. 1. The data processing apparatus 2 may include: a configuration acquisition module 100, a service parameter acquisition module 200, and a rendering module 300.

The configuration acquisition module 100 is configured to acquire a service environment configuration for a first map when performing scattering simulation rendering on the first map. The service parameter acquisition module 200 is configured to acquire, if the service environment configuration is a sample environment configuration, a service rendering parameter matching the sample environment configuration. The service rendering parameter is obtained after training an initial rendering parameter in a second rendering rule based on a predicted rendering value and an actual rendering value of a sample map in the sample environment configuration. The actual rendering value of the sample map is determined based on a sample volume texture of the sample map. The sample volume texture of the sample map is generated by a first rendering rule. The first rendering rule is configured for rendering a virtual scene containing a medium. The second rendering rule is configured for rendering a medium scattering effect. The rendering module 300 is configured to render a medium scattering effect of the first map based on the service rendering parameter and the second rendering rule to obtain a second map.

In some embodiments, the sample environment configuration is stored into a database. The service parameter acquisition module 200 is further configured to search, if the service environment configuration is the sample environment configuration, the database for a service rendering distribution diagram matching the sample environment configuration based on an association relationship of the sample environment configuration, the service rendering distribution diagram including a first rendering distribution diagram associated with first scattering parameters, a second rendering distribution diagram associated with second scattering parameters, and a third rendering distribution diagram associated with luminance parameters. determine a to-be-rendered angle corresponding to the first map; determine, in the first rendering distribution diagram, a scattering coefficient corresponding to the to-be-rendered angle as a first to-be-processed coefficient; determine, in the second rendering distribution diagram, a scattering coefficient corresponding to the to-be-rendered angle as a second to-be-processed coefficient; determine, in the third rendering distribution diagram, virtual light source luminance corresponding to the to-be-rendered angle as to-be-processed luminance; and determine the first to-be-processed coefficient, the second to-be-processed coefficient, and the to-be-processed luminance as the service rendering parameter matching the sample environment configuration.

In some embodiments, the apparatus further includes: a sample update module configured to determine, if the database does not have a sample environment configuration matching the service environment configuration, the service environment configuration as an updated sample configuration, and determine the first map as an updated sample map in the updated sample configuration; a reference update module configured to acquire a sample volume texture of the updated sample map generated by the first rendering rule; and determine, based on the sample volume texture of the updated sample map, an actual rendering value of the updated sample map in the updated sample configuration and reference depth data of the updated sample map; a prediction update module configured to determine a predicted rendering value of the updated sample map in the updated sample configuration based on the initial rendering parameter in the second rendering rule and the reference depth data of the updated sample map; a training update module configured to train the initial rendering parameter based on the actual rendering value of the updated sample map in the updated sample configuration and the predicted rendering value of the updated sample map in the updated sample configuration to obtain an updated rendering parameter matching the updated sample configuration; and a storage update module configured to store the updated sample configuration into the database based on the updated rendering parameter.

In some embodiments, referring to FIG. 9, FIG. 9 is a schematic diagram of a computer device according to an embodiment of this disclosure. As shown in FIG. 9, a computer device 1000 may be a computer device having a rendering function. The computer device 1000 may include: at least one processor 1001, for example, a central processing unit (CPU), at least one network interface 1004, a memory 1005, and at least one communications bus 1002. The communications bus 1002 is configured to realize the connection and communication among the components. The network interface 1004 may include a standard wired interface and a standard wireless interface (such as a WI-FI interface). The memory 1005 may be a high-speed random access memory (RAM), or may be a non-volatile memory, for example, at least one magnetic disk storage. In some embodiments, the memory 1005 may be at least one storage apparatus that is located far away from the foregoing processor 1001. As shown in FIG. 9, as a computer storage medium, the memory 1005 may include an operating system, a network communications module, a user interface module, and a device-control application program. In some embodiments, the computer device may further include a user interface 1003 shown in FIG. 9. For example, if the computer device is the terminal device having a rendering function shown in FIG. 1, for example, the terminal device 100a, the computer device may further include the user interface 1003. The user interface 1003 may include a display, a keyboard, and the like.

In the computer device 1000 shown in FIG. 9, the network interface 1004 is mainly configured for network communication. The user interface 1003 is mainly configured to provide an input interface for a user. The processor 1001 may be configured to invoke the device-control application program stored in the memory 1005 to implement: acquiring a rendering rule; the rendering rule including a first rendering rule and a second rendering rule; the first rendering rule being configured for rendering a virtual scene containing a medium; and the second rendering rule being configured for rendering a medium scattering effect; acquiring a sample volume texture of a sample map generated by the first rendering rule, and determining, based on the sample volume texture, an actual rendering value of the sample map in a sample environment configuration and reference depth data of the sample map; determining a predicted rendering value of the sample map in the sample environment configuration based on an initial rendering parameter in the second rendering rule and the reference depth data; and training the initial rendering parameter based on the predicted rendering value and the actual rendering value to obtain a service rendering parameter matching the sample environment configuration, the service rendering parameter being configured for rendering a medium scattering effect of a first map; and a service environment configuration of the first map being the sample environment configuration.

The processor 1001 may further be configured to invoke the device-control application program stored in the memory 1005 to implement: acquiring a service environment configuration for a first map when performing scattering simulation rendering on the first map; acquiring, if the service environment configuration is a sample environment configuration, a service rendering parameter matching the sample environment configuration, the service rendering parameter being obtained after training an initial rendering parameter in a second rendering rule based on a predicted rendering value and an actual rendering value of a sample map in the sample environment configuration; the actual rendering value of the sample map being determined based on a sample volume texture of the sample map; the sample volume texture of the sample map being generated by a first rendering rule; the first rendering rule being configured for rendering a virtual scene containing a medium; and the second rendering rule being configured for rendering a medium scattering effect; and rendering a medium scattering effect of the first map based on the service rendering parameter and the second rendering rule to obtain a second map.

The computer device 1000 described in this embodiment of this disclosure may perform the descriptions of the data processing methods in the foregoing embodiments corresponding to FIG. 3 and FIG. 5 and may also perform the descriptions of the data processing apparatus 1 in the foregoing embodiment corresponding to FIG. 7 or the data processing apparatus 2 in the foregoing embodiment corresponding to FIG. 8. Details are not described herein again. In addition, the descriptions of beneficial effects of the same method are not described herein again.

The embodiments of this disclosure further provide a computer-readable storage medium, having a computer program executed by the foregoing data processing apparatus 1 or the foregoing data processing apparatus 2 stored therein. The computer program includes program instructions. When executing the program instructions, a processor can perform the description of the data processing method in the foregoing embodiment corresponding to FIG. 3 or FIG. 5. Therefore, details are not described herein again. In addition, the descriptions of beneficial effects of the same method are not described herein again. Technical details that are not disclosed in the computer-readable storage medium embodiment of this disclosure refer to the descriptions of the method embodiments of this disclosure. As an example, the program instructions may be deployed to be executed on one computer device, on a plurality of computer devices located at one place, or on a plurality of computer devices distributed at a plurality of places and interconnected through a communication network. The plurality of computer devices distributed at the plurality of places and interconnected through the communication network may form a blockchain system.

The embodiments of this disclosure further provide a computer-readable storage medium, having a computer program stored therein. The computer program includes program instructions, and when the program instructions are executed by a processor, the data processing methods provided in the operations of FIG. 3 and FIG. 5 may be implemented. This implementation may refer to the implementations provided by the operations of FIG. 3 and FIG. 5. Details are not described herein again.

In some embodiments, referring to FIG. 10, FIG. 10 is a schematic structural diagram of a data processing system according to an embodiment of this disclosure. A data processing system 3 may include a data processing apparatus 1a and a data processing apparatus 2a. The data processing apparatus 1a may be the data processing apparatus 1 in the foregoing embodiment corresponding to FIG. 7. The data processing apparatus 1a may be integrated into the foregoing computer device having a rendering function. The computer device may be the server 10F in the foregoing embodiment corresponding to FIG. 1, or may be any terminal device, for example, the terminal device 100a, in the terminal device cluster in the foregoing embodiment corresponding to FIG. 1. Therefore, details are not described herein again. The data processing apparatus 2a may be the data processing apparatus 2 in the foregoing embodiment corresponding to FIG. 8. The data processing apparatus 2a may be integrated into the foregoing computer device having a rendering function. The computer device may be the server 10F in the foregoing embodiment corresponding to FIG. 1, or may be any terminal device, for example, the terminal device 100a, in the terminal device cluster in the foregoing embodiment corresponding to FIG. 1. Therefore, details are not described herein again. In addition, the descriptions of beneficial effects of the same method are not described herein again. Technical details that are not disclosed in the data processing system embodiment of this disclosure refer to the descriptions of the method embodiments of this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

It is noted that all or some of the procedures in the methods of the foregoing embodiments may be accomplished by instructing the relevant hardware through the computer program. The foregoing program may be stored on a computer-readable storage medium and may include the procedures of the foregoing method embodiments when executed. The foregoing storage medium may be a magnetic disk, an optical disc, a read-only memory (ROM), a RAM, or the like.

What is disclosed above is merely exemplary embodiments of this disclosure, and certainly is not intended to limit the scope of the claims of this disclosure. Therefore, variations made in accordance with the claims of this disclosure shall fall within the scope of this disclosure.

What is claimed is:

1. A method of data processing, comprising:
acquiring a first rendering rule and a second rendering rule, the first rendering rule being configured for virtual scene rendering with more medium effects than the second rendering rule, and the second rendering rule being configured for rendering with a medium scattering effect;
acquiring a sample volume texture of a sample map in a sample environment configuration, the sample volume texture being generated by the first rendering rule;
determining, based on the sample volume texture, one or more first rendering values of the sample map and reference depth data of the sample map in the sample environment configuration;
determining one or more second rendering values of the sample map in the sample environment configuration based on the reference depth data and the second rendering rule with an initial rendering parameter for training; and
performing the training based on the one or more second rendering values and the one or more first rendering values to obtain a service rendering parameter associated with the sample environment configuration.

2. The method according to claim 1, wherein the acquiring the sample volume texture comprises:
acquiring reference attributes for the sample map; and
acquiring, based on the sample map and a virtual light source elevation angle in the reference attributes, the sample volume texture that matches with the virtual light source elevation angle.

3. The method according to claim 2, wherein the determining the one or more first rendering values comprises:
acquiring a preset depth data set comprising N initial depths;
determining sliced data of the sample volume texture at the virtual light source elevation angle based on the N initial depths, the sliced data comprising N sample sub-images respectively corresponding to the N initial depths, and N being a positive integer;
determining, from the N sample sub-images, a reference image of the sample map at the virtual light source elevation angle;
determining one or more rendering values of the reference image to be the one or more first rendering values of the sample map in the sample environment configuration; and
determining the reference depth data based on a corresponding initial depth of the reference image.

4. The method according to claim 2, wherein the virtual light source elevation angle comprises a solar elevation angle, the sample volume texture comprises a first sample volume texture for a daytime simulation in the sample environment configuration and a second sample volume texture for a sunset simulation in the sample environment configuration, and
the acquiring the reference attributes comprises:
displaying a service configuration interface of an atmospheric rendering component in a service engine, the service configuration interface comprising a configuration control for the solar elevation angle;
in response to an attribute addition operation of the configuration control, acquiring a first elevation angle for the first sample volume texture and a second elevation angle for the second sample volume texture, the first elevation angle being greater than the second elevation angle; and
including the first elevation angle and the second elevation angle in the reference attributes for the sample map.

5. The method according to claim 3, wherein the determining the reference image comprises:
for a respective sample sub-image in the N sample sub-images:
rasterizing a texture grid of the respective sample sub-image to obtain coordinate positions corresponding to pixel points in the respective sample sub-image; and
performing superimposition on pixel values of the pixel points based on the coordinate positions corresponding to the pixel points to obtain a respective total pixel value of the respective sample sub-image; and
selecting, from the N sample sub-images, the reference image that has a maximum total pixel value.

6. The method according to claim 2, wherein the initial rendering parameter comprises a first scattering parameter, a second scattering parameter, and a luminance parameter, the first scattering parameter and the second scattering parameter respectively correspond to different scattering manners, the luminance parameter indicates a virtual light source luminance,
the determining the one or more second rendering values comprises:
acquiring an initial rendering value of the sample map;
determining a transmittance of the sample map based on a first initial scattering coefficient of the first scattering parameter, a second initial scattering coefficient of the second scattering parameter, and the reference depth data;
determining an internal scattering parameter of the sample map at the virtual light source elevation angle based on the first initial scattering coefficient of the first scattering parameter, the second initial scattering coefficient of the second scattering parameter, the luminance parameter, and the reference depth data; and
determining a second rendering value in the one or more second rendering values of the sample map in the sample environment configuration based on the initial rendering value, the transmittance, and the internal scattering parameter.

7. The method according to claim 6, wherein
the virtual light source elevation angle refers to an elevation angle of a directional light emitted by a virtual light source, and
the determining the internal scattering parameter comprises:
determining an included angle between the directional light emitted by the virtual light source and a current line of sight;
determining a first updated scattering coefficient of the first scattering parameter based on the first initial scattering coefficient of the first scattering parameter and the included angle;
determining a second updated scattering coefficient of the second scattering parameter based on the second initial scattering coefficient of the second scattering parameter and the included angle; and
determining the internal scattering parameter of the sample map at the virtual light source elevation angle based on the first initial scattering coefficient of the first scattering parameter, the first updated scattering coefficient of the first scattering parameter, the second initial scattering coefficient of the second scattering parameter, the second updated scattering coefficient of the second scattering parameter, the luminance parameter, and the reference depth data.

8. The method according to claim 1, wherein the training comprises:
determining a total rendering loss of the sample map based on the one or more second rendering values and the one or more first rendering values;
performing an iterative training on the initial rendering parameter based on the total rendering loss to obtain a parameter training result; and
determining, when the parameter training result indicates that an updated rendering parameter obtained after the iterative training satisfies a training cut-off condition, the updated rendering parameter to be the service rendering parameter associated with the sample environment configuration.

9. The method according to claim 8, wherein
the sample map comprises M pixel points, M is a positive integer, the M pixel points comprise a pixel point Xᵢ, i is a positive integer less than or equal to M, and
the determining the total rendering loss comprises:
acquiring a second rendering value Yᵢ of the pixel point Xᵢ from the one or more second rendering values;
acquiring a first rendering value yᵢ of the pixel point Xᵢ from the one or more first rendering values;
determining a rendering difference between the second rendering value Yᵢ and the first rendering value yᵢ as a rendering loss of the pixel point Xᵢ; and
determining the total rendering loss based on M rendering losses of the M pixel points.

10. The method according to claim 4, wherein the service rendering parameter is a rendering parameter corresponding to a target virtual light source elevation angle in the sample environment configuration, the target virtual light source elevation angle is an angle in Z virtual light source elevation angles, Z is a positive integer greater than 1, the Z virtual light source elevation angles are elevation angles acquired in response to a trigger operation performed on the configuration control for the reference attributes,
the method further comprises:
acquiring Z rendering parameters respectively corresponding to the Z virtual light source elevation angles, each of the Z rendering parameters comprising a first scattering parameter, a second scattering parameter, and a luminance parameter;
determining, from the Z rendering parameters, first scattering coefficients associated with the first scattering parameters to obtain Z first scattering coefficients;
fitting the Z first scattering coefficients within an angle interval of the virtual light source elevation angle to obtain a first rendering distribution diagram associated with the first scattering parameters;
determining, from the Z rendering parameters, second scattering coefficients associated with the second scattering parameters to obtain Z second scattering coefficients;
fitting the Z second scattering coefficients within the angle interval of the virtual light source elevation angle to obtain a second rendering distribution diagram associated with the second scattering parameters;
determining, from the Z rendering parameters, virtual light source luminance associated with the luminance parameters to obtain Z pieces of virtual light source luminance;
fitting the Z pieces of virtual light source luminance within the angle interval of the virtual light source elevation angle to obtain a third rendering distribution diagram associated with the luminance parameters; and
determining the first rendering distribution diagram, the second rendering distribution diagram, and the third rendering distribution diagram as a service rendering distribution diagram associated with the sample environment configuration.

11. A method of data processing, comprising:
acquiring a service environment configuration for a first map when a scattering simulation rendering is to be performed on the first map according to a second rendering rule, the second rendering rule having one or more parameters that are trained based on a first rendering rule with more medium effects than the second rendering rule;
acquiring, when the service environment configuration corresponds to a sample environment configuration being trained, a service rendering parameter associated with the sample environment configuration, the service rendering parameter being obtained by a training with an initial rendering parameter in the second rendering rule based on one or more first rendering values of a sample map in the sample environment configuration, the one or more first rendering values of the sample map being determined based on a sample volume texture of the sample map, the sample volume texture of the sample map being generated by the first rendering rule; and
rendering a medium scattering effect of the first map based on the service rendering parameter and the second rendering rule to obtain a second map.

12. The method according to claim 11, wherein
the sample environment configuration is stored in a database, and
the acquiring the service rendering parameter associated with the sample environment configuration comprises:
searching the database for a service rendering distribution diagram associated with the sample environment configuration, the service rendering distribution diagram comprising a first rendering distribution diagram associated with first scattering parameters, a second rendering distribution diagram associated with second scattering parameters, and a third rendering distribution diagram associated with luminance parameters;
determining a to-be-rendered angle of the first map;
determining, based on the first rendering distribution diagram, a first to-be-processed coefficient corresponding to the to-be-rendered angle;
determining, based on the second rendering distribution diagram, a second to-be-processed coefficient corresponding to the to-be-rendered angle;
determining, based on the third rendering distribution diagram, a to-be-processed luminance corresponding to the to-be-rendered angle; and
acquiring the first to-be-processed coefficient, the second to-be-processed coefficient, and the to-be-processed luminance as the service rendering parameter associated with the sample environment configuration.

13. The method according to claim 12, further comprising:
determining, when the database does not have a sample environment configuration associated with the service environment configuration, the service environment configuration to be an updated sample configuration, the first map being set as an updated sample map for the updated sample configuration;
acquiring an updated sample volume texture of the updated sample map in the updated sample configuration, the updated sample volume texture being generated by the first rendering rule;
determining, based on the updated sample volume texture of the updated sample map, one or more updated first rendering values of the updated sample map in the updated sample configuration and reference depth data of the updated sample map;
determining one or more updated second rendering values of the updated sample map in the updated sample configuration based on the reference depth data and the second rendering rule with the initial rendering parameter;
performing training based on the one or more updated first rendering values and the one or more updated second rendering values to obtain an updated rendering parameter associated with the updated sample configuration; and
storing, into the database, the updated sample configuration associated with the updated rendering parameter.

14. A data processing apparatus, comprising processing circuitry configured to:
acquire a first rendering rule and a second rendering rule, the first rendering rule being configured for virtual scene rendering with more medium effects than the second rendering rule, and the second rendering rule being configured for rendering with a medium scattering effect;
acquire a sample volume texture of a sample map in a sample environment configuration, the sample volume texture being generated by the first rendering rule;
determine, based on the sample volume texture, one or more first rendering values of the sample map and reference depth data of the sample map in the sample environment configuration;
determine one or more second rendering values of the sample map in the sample environment configuration based on the reference depth data and the second rendering rule with an initial rendering parameter for a training; and
perform the training based on the one or more second rendering values and the one or more first rendering values to obtain a service rendering parameter associated with the sample environment configuration.

15. The data processing apparatus according to claim 14, wherein the processing circuitry is configured to:
acquire reference attributes for the sample map; and
acquire, based on the sample map and a virtual light source elevation angle in the reference attributes, the sample volume texture that matches with the virtual light source elevation angle.

16. The data processing apparatus according to claim 15, wherein the processing circuitry is configured to:
acquire a preset depth data set comprising N initial depths;
determine sliced data of the sample volume texture at the virtual light source elevation angle based on the N initial depths, the sliced data comprising N sample sub-images respectively corresponding to the N initial depths, and N being a positive integer;
determine, from the N sample sub-images, a reference image of the sample map at the virtual light source elevation angle;
determine one or more rendering values of the reference image to be the one or more first rendering values of the sample map in the sample environment configuration; and
determine the reference depth data based on a corresponding initial depth of the reference image.

17. The data processing apparatus according to claim 15, wherein
the virtual light source elevation angle comprises a solar elevation angle, the sample volume texture comprises a first sample volume texture for a daytime simulation in the sample environment configuration and a second sample volume texture for a sunset simulation in the sample environment configuration, and
the processing circuitry is configured to:
display a service configuration interface for an atmospheric rendering component in a service engine, the service configuration interface comprising a configuration control for the solar elevation angle;
in response to an attribute addition operation of the configuration control, acquire a first elevation angle for the first sample volume texture and a second elevation angle for the second sample volume texture, the first elevation angle being greater than the second elevation angle; and
include the first elevation angle and the second elevation angle in the reference attributes for the sample map.

18. The data processing apparatus according to claim 16, wherein the processing circuitry is configured to:
for a respective sample sub-image in the N sample sub-images:
rasterize a texture grid of the respective sample sub-image to obtain coordinate positions corresponding to pixel points in the respective sample sub-image; and
perform superimposition on pixel values of the pixel points based on the coordinate positions corresponding to the pixel points to obtain a respective total pixel value of the respective sample sub-image; and
select, from the N sample sub-images, the reference image that has a maximum total pixel value.

19. The data processing apparatus according to claim 15, wherein the initial rendering parameter comprises a first scattering parameter, a second scattering parameter, and a luminance parameter, the first scattering parameter and the second scattering parameter respectively correspond to different scattering manners, the luminance parameter is configured for indicating a virtual light source luminance, and
the processing circuitry is configured to:
acquire an initial rendering value of the sample map;
determine a transmittance of the sample map based on a first initial scattering coefficient of the first scattering parameter, a second initial scattering coefficient of the second scattering parameter, and the reference depth data;
determine an internal scattering parameter of the sample map at the virtual light source elevation angle based on the first initial scattering coefficient of the first scattering parameter, the second initial scattering coefficient of the second scattering parameter, the luminance parameter, and the reference depth data; and
determine a second rendering value in the one or more second rendering values of the sample map in the sample environment configuration based on the initial rendering value, the transmittance, and the internal scattering parameter.

20. The data processing apparatus according to claim 19, wherein
the virtual light source elevation angle refers to an elevation angle of a directional light emitted by a virtual light source, and
the processing circuitry is configured to:
determine an included angle between the directional light emitted by the virtual light source and a current line of sight;
determine a first updated scattering coefficient of the first scattering parameter based on the first initial scattering coefficient of the first scattering parameter and the included angle;
determine a second updated scattering coefficient of the second scattering parameter based on the second initial scattering coefficient of the second scattering parameter and the included angle; and
determine the internal scattering parameter of the sample map at the virtual light source elevation angle based on the first initial scattering coefficient of the first scattering parameter, the first updated scattering coefficient of the first scattering parameter, the second initial scattering coefficient of the second scattering parameter, the second updated scattering coefficient of the second scattering parameter, the luminance parameter, and the reference depth data.
